(19) United States
(12) Patent Application Publication
(10) Pub. No.: US 2014/0379853 A1
(43) Pub. Date: Dec. 25, 2014

(54) METHOD OF DISTRIBUTING A MULTI-USER SOFTWARE APPLICATION

(71) Applicant: Daniel Shelton, Berkshire (GB)

(72) Inventor: Daniel Shelton, Berkshire (GB)

(73) Assignee: Antix Labs, Ltd., Berkshire (GB)

(21) Appl. No.: 14/117,247

(22) PCT Filed: May 11, 2012
(86) PCT No.: PCT/EP12/58744

§ 371 Date: Sep. 15, 2014

(30) Foreign Application Priority Data
May 13, 2011 (GB) 1107978.7

(51) Int. Cl. H04L 29/08

(52) U.S. Cl. CPC H04L 67/10
USPC 709/217

(57) ABSTRACT

A method of distributing a multi-user software application utilises host and remote programs running on respective host and remote devices. Both programs are distributed together as a single package allowing the host device to send the remote program to the remote device, or the remote device to send the host program to the host device.

### 1. FIELD OF THE INVENTION, AND OVERVIEW

The present invention relates to a method of distributing a multi-user software application, and to computer readable media carrying such software. It relates in particular, although not exclusively, to software such as computer games which are designed to be exchanged between users of portable devices such as mobile phones.

The invention includes a system for transferring from one end-user device to another an entire binary-portable computer software application, including any libraries required by the application and saved application state. The binary-portable nature of the computer software application allows this to happen across dissimilar types of devices, including different CPU types and operating-systems.

This enables use-cases which are not typically possible using traditional systems, such as taking an in-progress saved game on one device, transferring the game, libraries and game state to a second device and then continuing to play the game from the same point on the second device, all without any requirement to have a connection to a server to download the necessary libraries or an installation package for the application.

This allows off-network distribution of applications and their state, reducing costs for the end-user, reducing network load, and speeding up the transfer of the application.

### 1.1 BACKGROUND

Display and input-device virtualisation have been common for a number of years. This entails a host device and a remote device communicating over a some communication link to display either the entire screen or one or more windows from the host device on the remote device's display, and forwarding input events such as keyboard and mouse events from the remote device to the host device to be processed as if they had happened locally on the host device.

Examples of this approach include X-Windows, Microsoft Remote Desktop Connection, and VNC.

In all of these cases, the output of the host system is transmitted to the remote system for display, typically encoded as a sequence of rendering instructions rather than as a sequence of screen captures, as this results in less communications traffic and thus improved performance.

In the case of Microsoft Remote Desktop Connection and VNC, the remote device typically displays the same information as the host device. In X-Windows, the remote device typically acts as the primary display for certain programs running on the host system.

More recent implementations of this approach include Microsoft Windows Media Center Extenders, and the Playstation-3 Remote Play facility. In both of these cases, the host device transmits a set of instructions describing the information to be displayed to the user, such as menus and available content, and when the user selects a piece of content an encoded video stream is transmitted to the remote device, which decodes and displays it.

Implementations of VNC and X-Windows have been made in binary-portable programming environments such as Java.

The systems described above are typically generic services which are not specific to the application whose input and output are being presented remotely. However, there are other systems where both the communications protocol and the program displaying the results on the remote device are specific to the host program.

In these systems, the purpose of the remote program is not simply to display the normal output of an application on the host device (effectively acting as an auxiliary display and set of input devices), but instead to display different information about the state of the host application, and to guide the user to provide input to the host application. The remote program is written with knowledge of the host application's data structures and logic, and the information transmitted between the two ends typically represents semantic objects representing the host program's state instead of explicit rendering instructions, and higher-level representations of user actions such as information that a particular item has been selected from a list, rather than the raw key presses or mouse movements.

The display of a user-interface is done by the remote program based on the information that it holds about the host program's state, allowing vastly less network traffic to be used than the previously described approach. Graphical, audio and other assets may be packaged with the remote program or they may be transferred across the communication link from the host program as required.

The “Meteor” application for Windows Phone 7 devices is an example of this approach—this application connects to a PC running the Windows Media Center application and displays a user-interface allowing the user of the phone to control the operation of the Windows Media Center, including showing the available content, TV guide listings, etc.

Such systems have again been implemented using binary-portable code (for example, the “Meteor” program described above is implemented in the .NET framework, which is a binary-portable system).

### 1.2 SUMMARY

The system described in this document is an extension to the second type of system described above—the application-specific remote program with a custom communication protocol.

Typically, these systems require the user to manually install both the host application program on the host device, and the remote application program on the remote device.

This document describes a system and method whereby the “host program” and the “remote program” are packaged and distributed together, and where the software platform underlying these application programs provides a facility for automatically sending either or both of these programs from a first computing device to a second computing device, such that one of these devices acts as the “remote device” in the scenario described above, and the other acts as the “host device”. The choice of which device performs which role depends on the user.

This document also describes a system and method where the first device uses a broadcast mechanism over one or more communication mediums to discover devices which are accessible and which support the necessary network protocols and software features to enable this system to work.

The process of deploying the programs to the target device is triggered by the user and takes place with a minimum of user interaction—selection of the target device and the item or items to send are the minimum requirements. In addition, there may be some security interaction required—for example entering a personal identification number on both devices either each time this process happens, or only on the first occasion (“pairing” the devices).

In the preferred embodiment, the host program and the remote program are implemented in a binary-portable software system, such that they can be transferred between dissimilar device types, including devices with different form-factors (such as personal computers, digital televisions, set-top boxes, mobile phones, etc), and devices with different and otherwise incompatible CPUs.

A single software application (program) may implement both the host program functionality and the remote program functionality.

The invention may be carried into practice in a number of ways and a variety of specific embodiments will now be described, with reference to the accompanying drawings, in which:

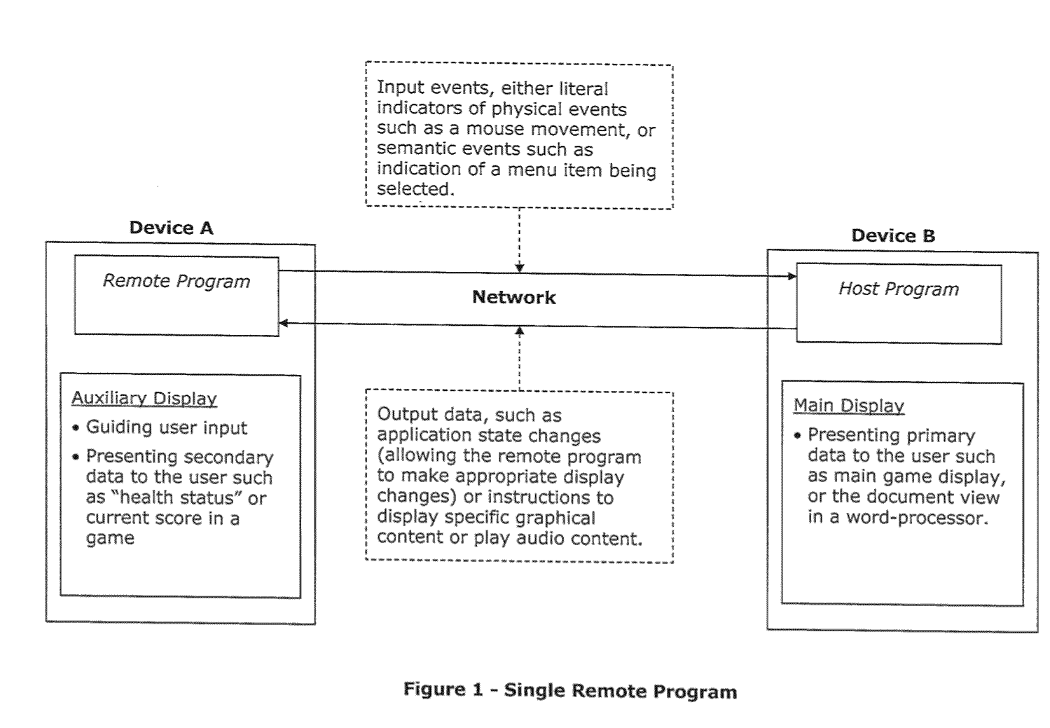

FIG. 1 shows a single remote program embodying the invention;

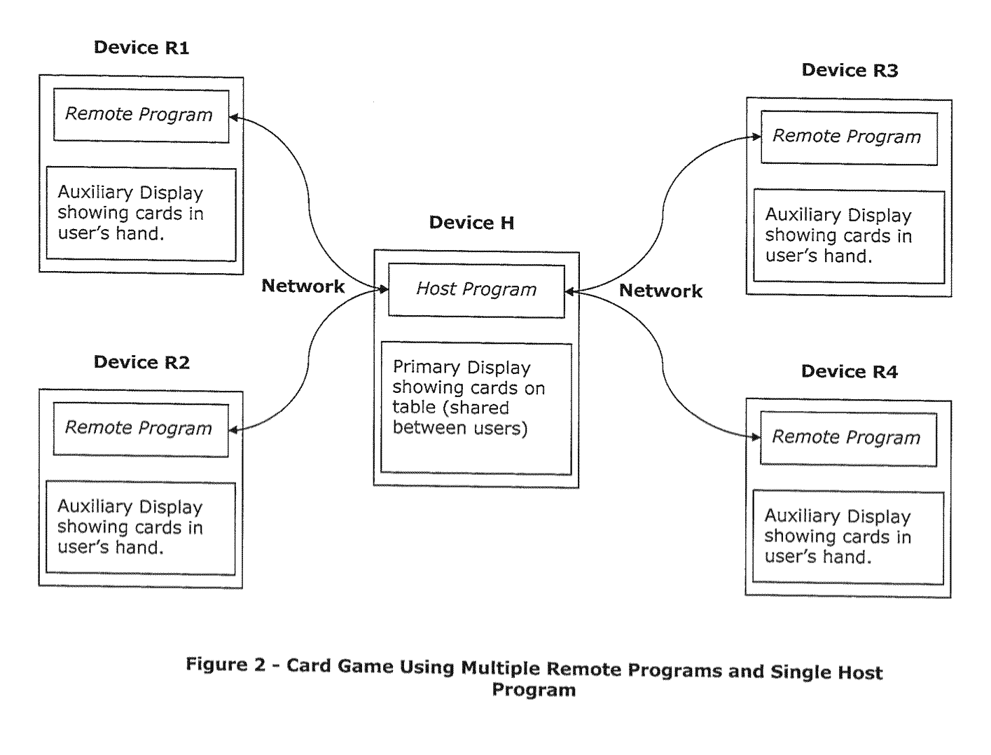

FIG. 2 shows a card game using multiple remote programs and single host program;

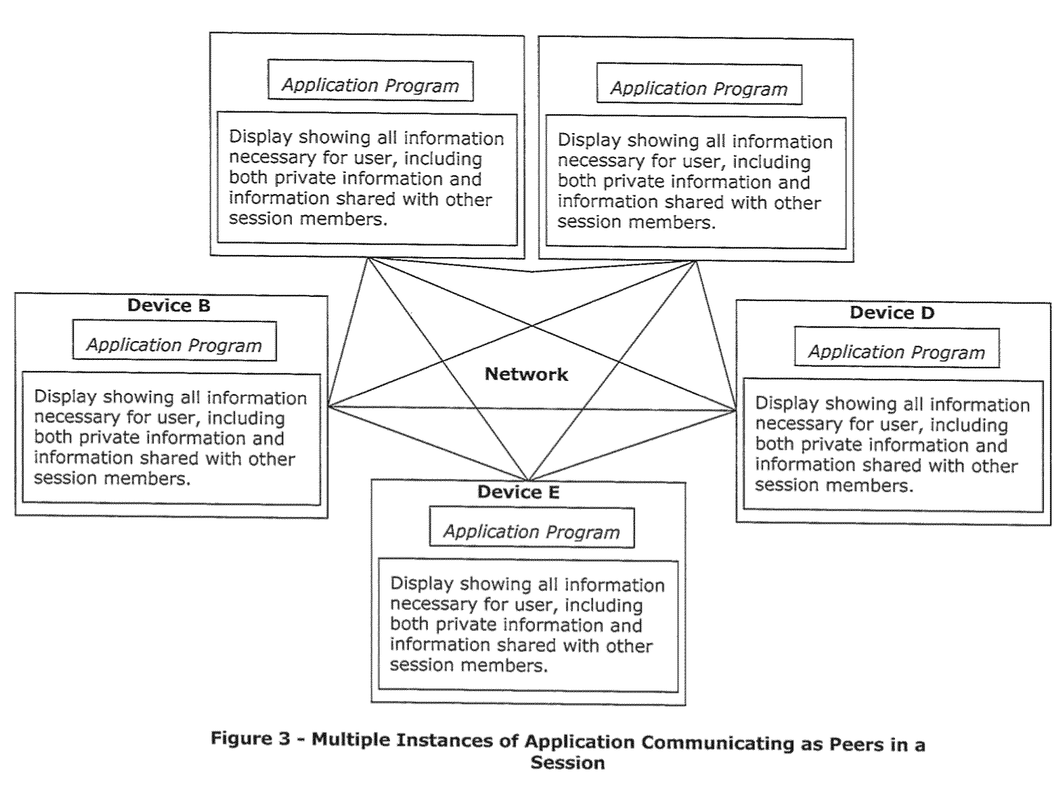

FIG. 3 shows a multiple instances of application communicating as peers in a session;

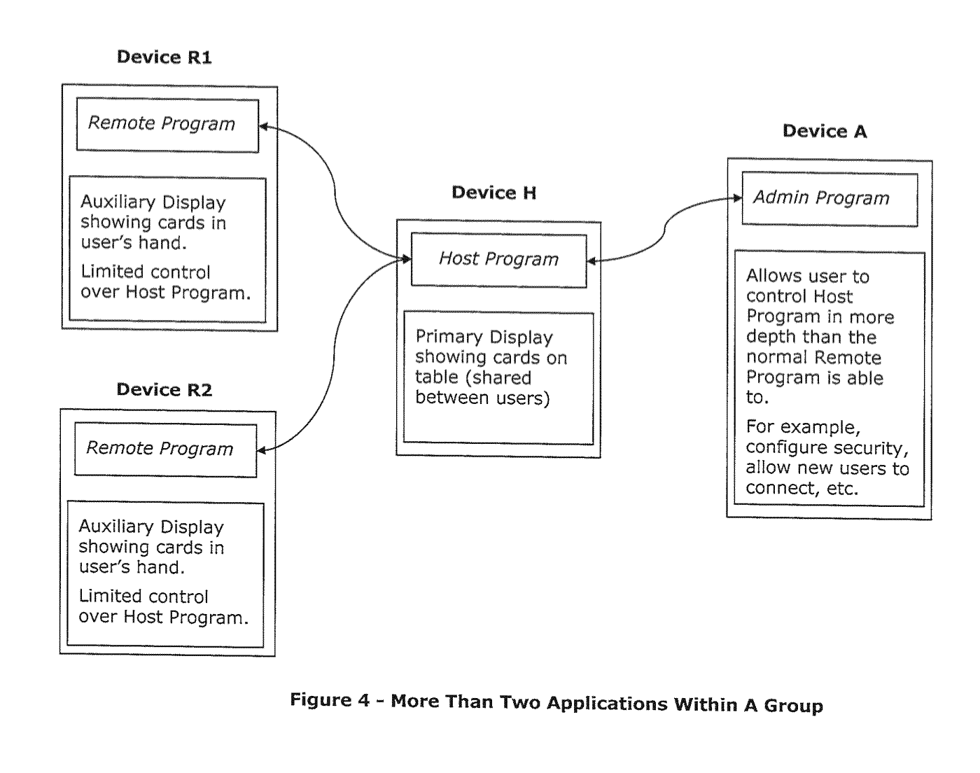

FIG. 4 shows more than two applications within a group;

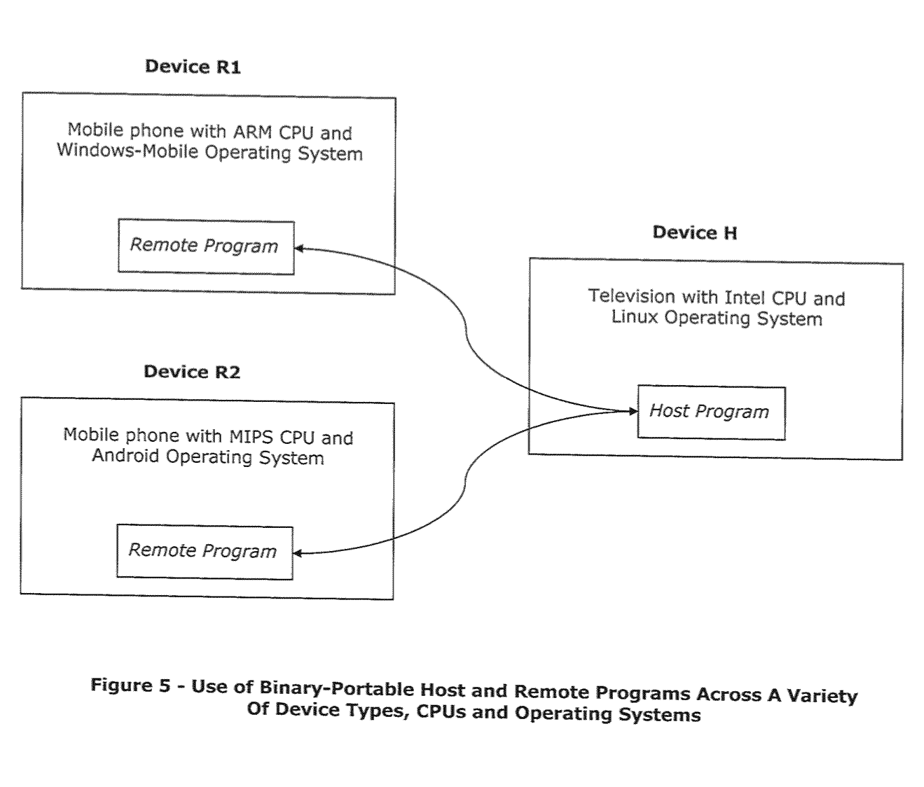

FIG. 5 shows the use of binary-portable host and remote programs across a variety of device types, CPUS and operating systems;

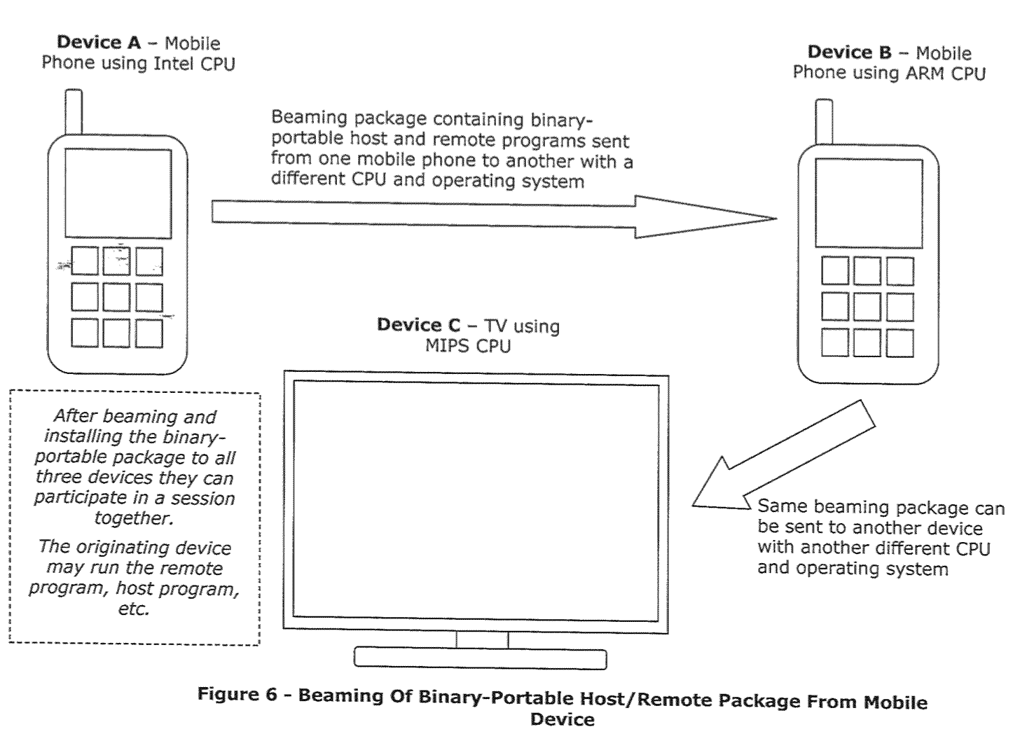

FIG. 6 shows beaming of binary-portable host/remote package from mobile device;

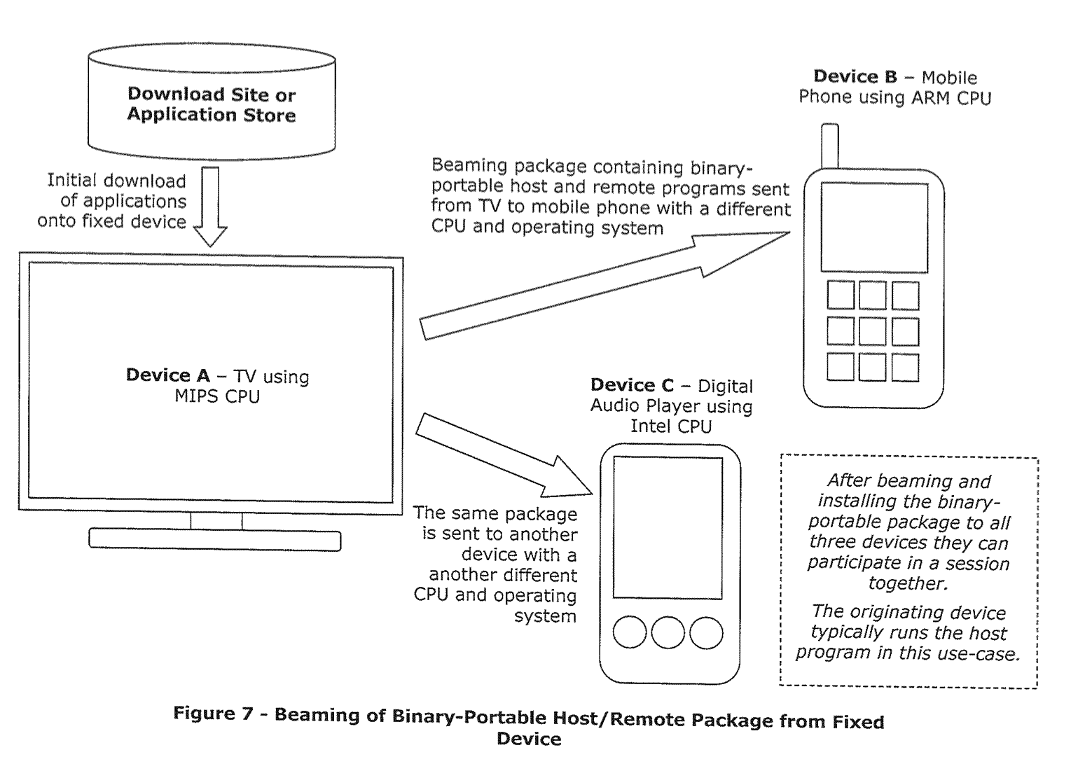

FIG. 7 shows beaming of binary-portable host/remote package from fixed device;

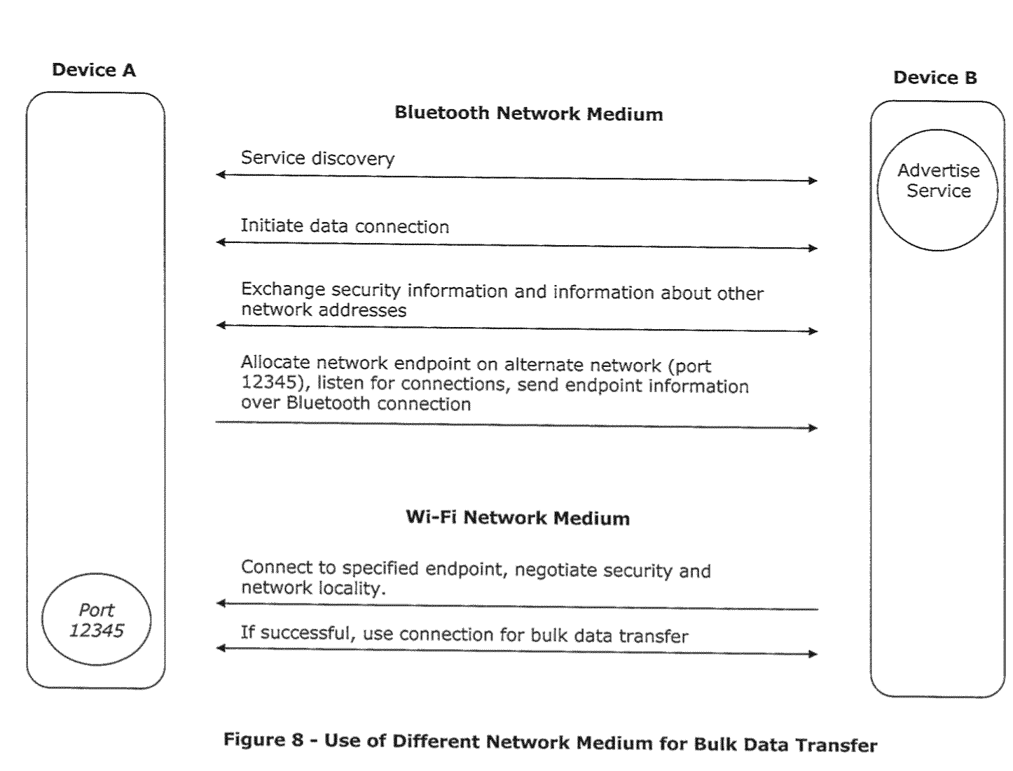

FIG. 8 shows the use of different network medium for bulk data transfer;

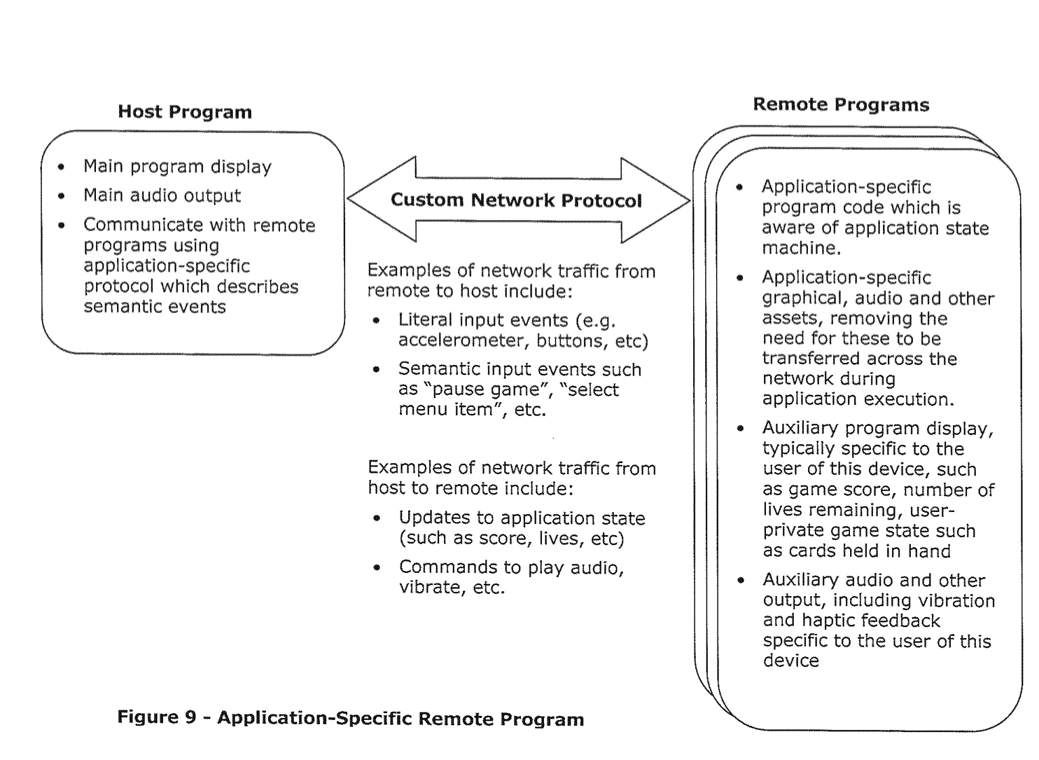

FIG. 9 shows an application-specific remote program;

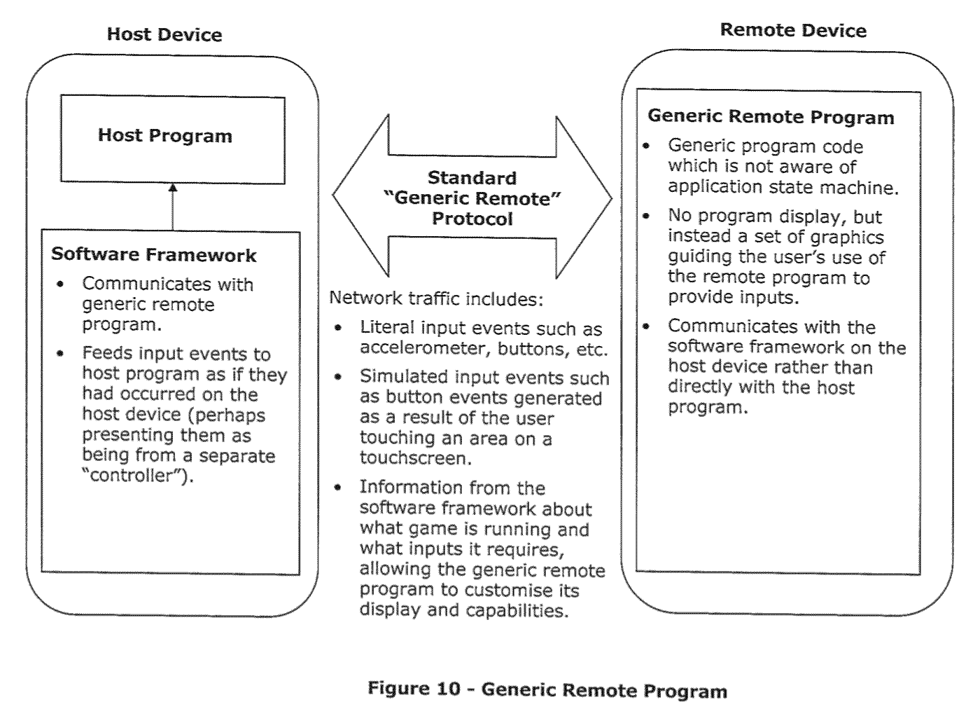

FIG. 10 shows a generic remote program;

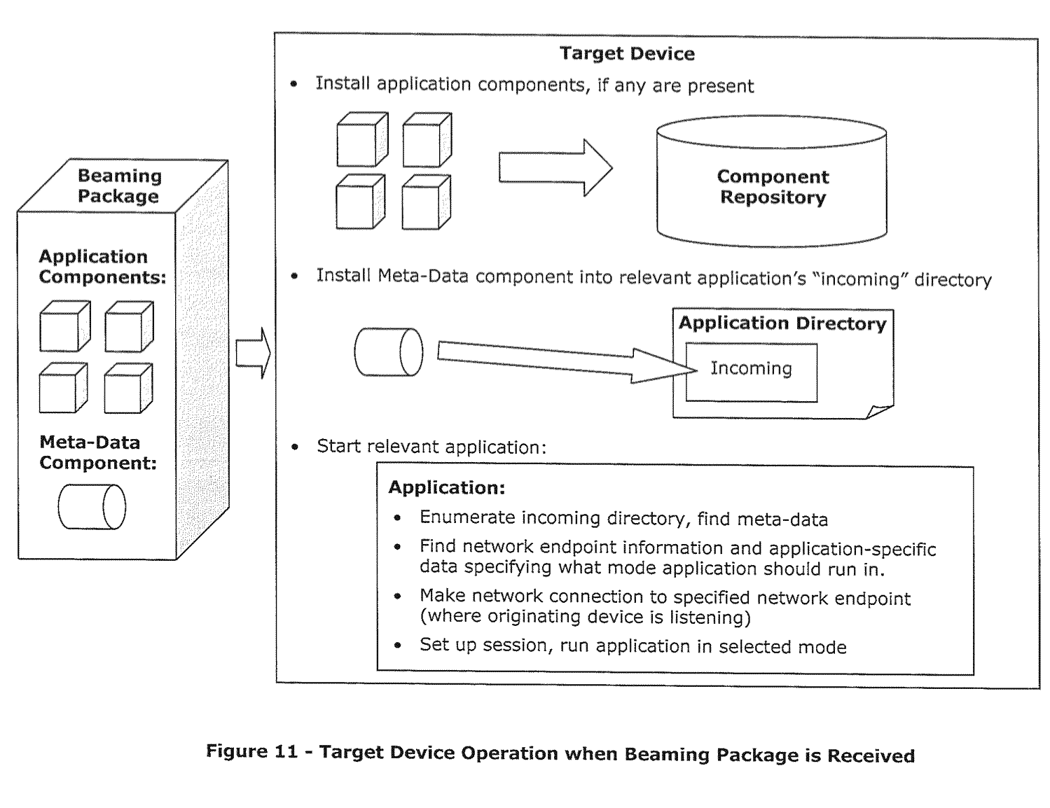

FIG. 11 shows a target device operation when beaming package is received;

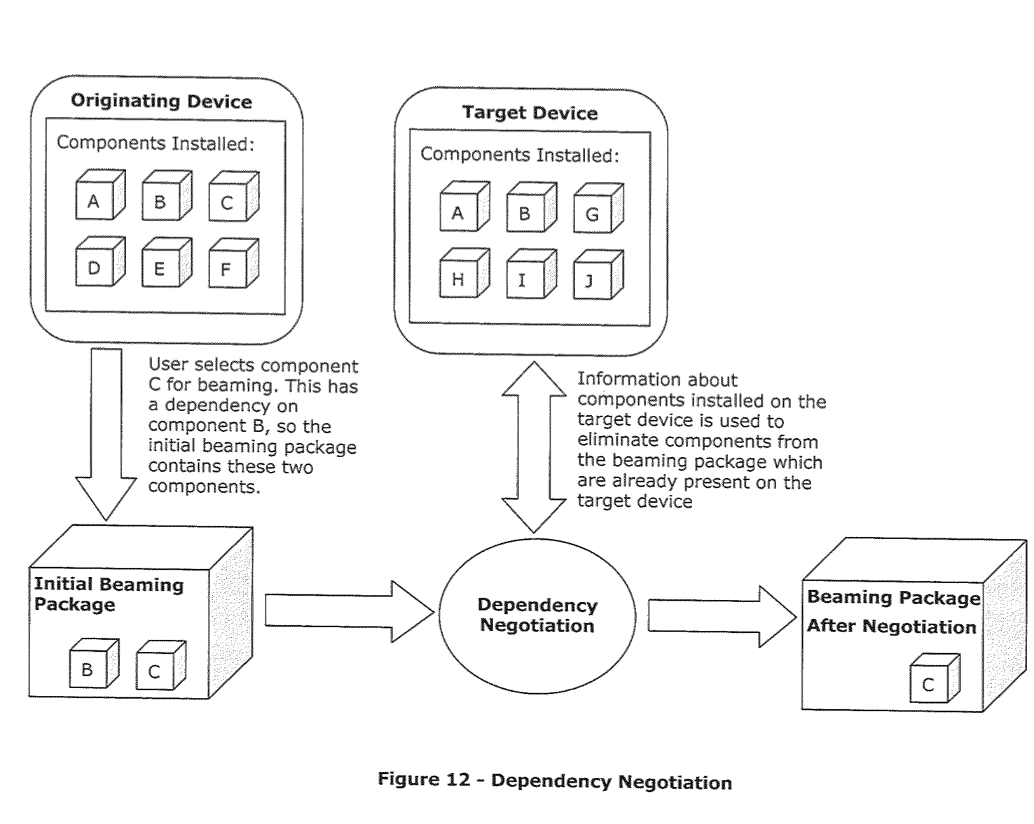

FIG. 12 shows dependency negotiation;

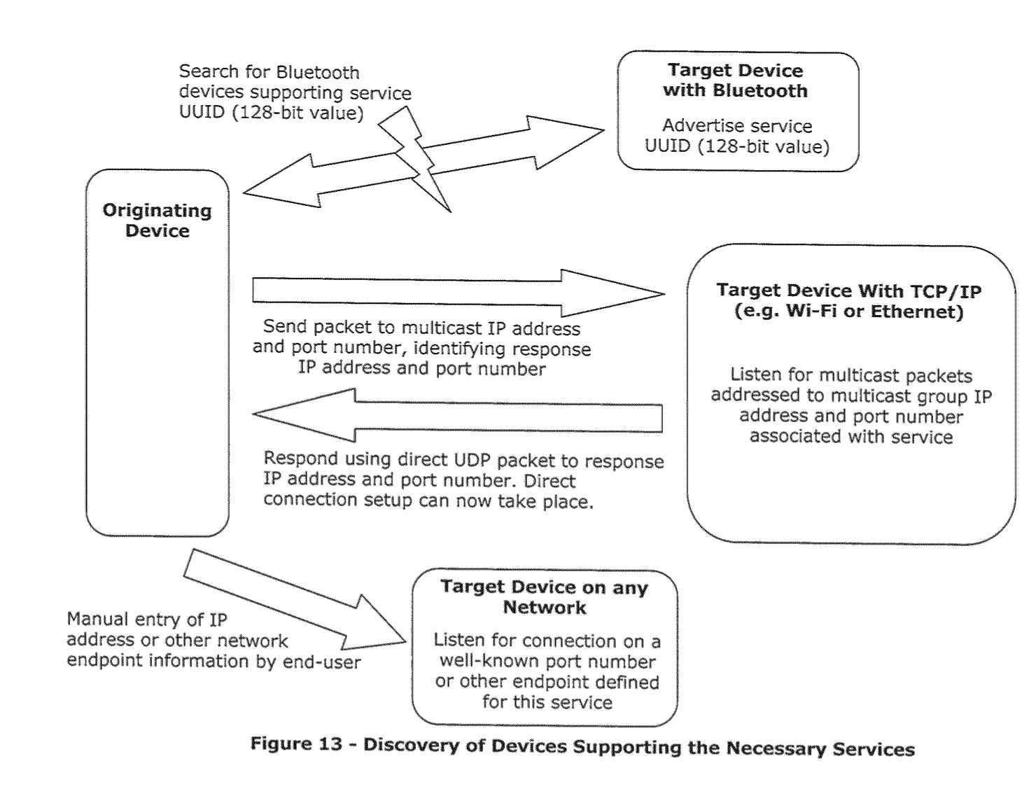

FIG. 13 shows discovery of devices supporting the necessary services;

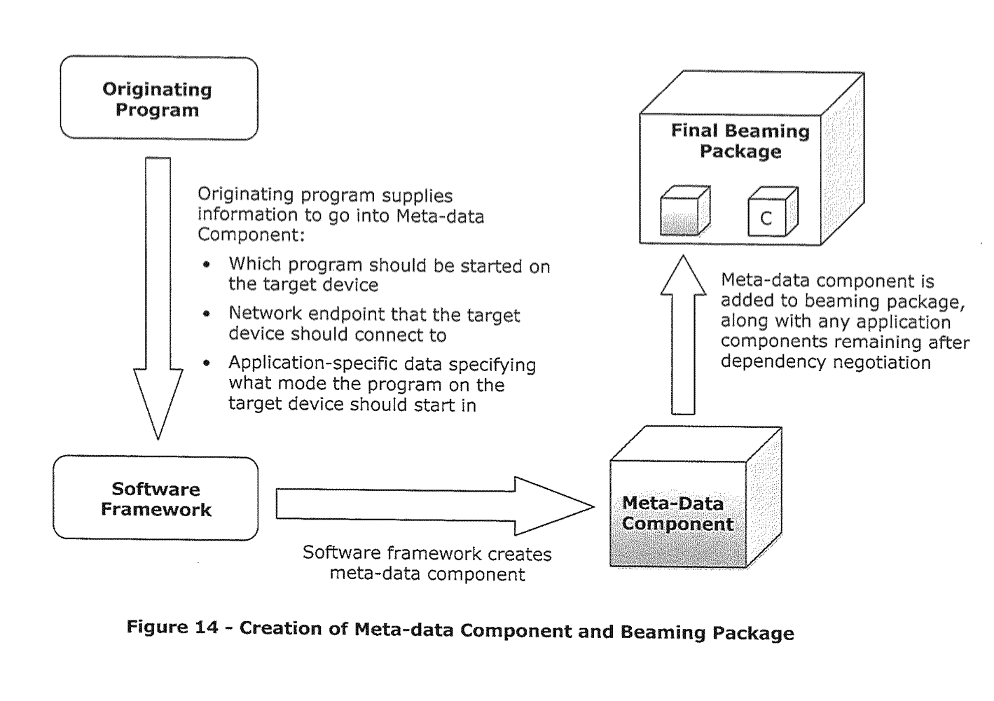

FIG. 14 shows creation of meta-data component and beaming package;

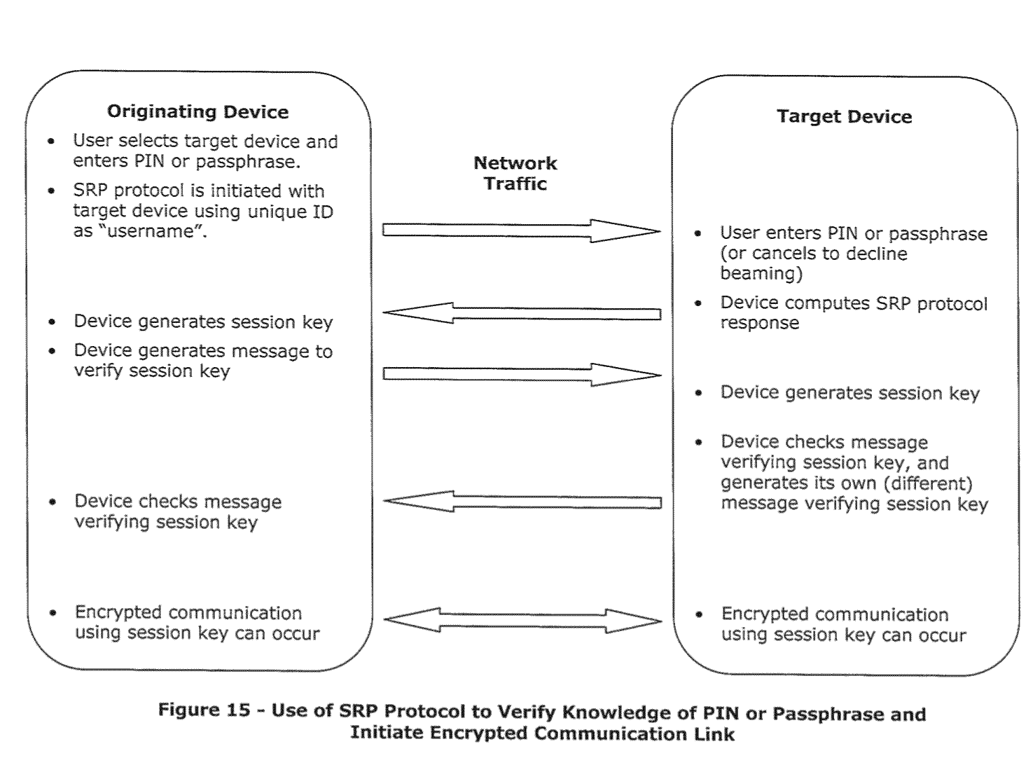

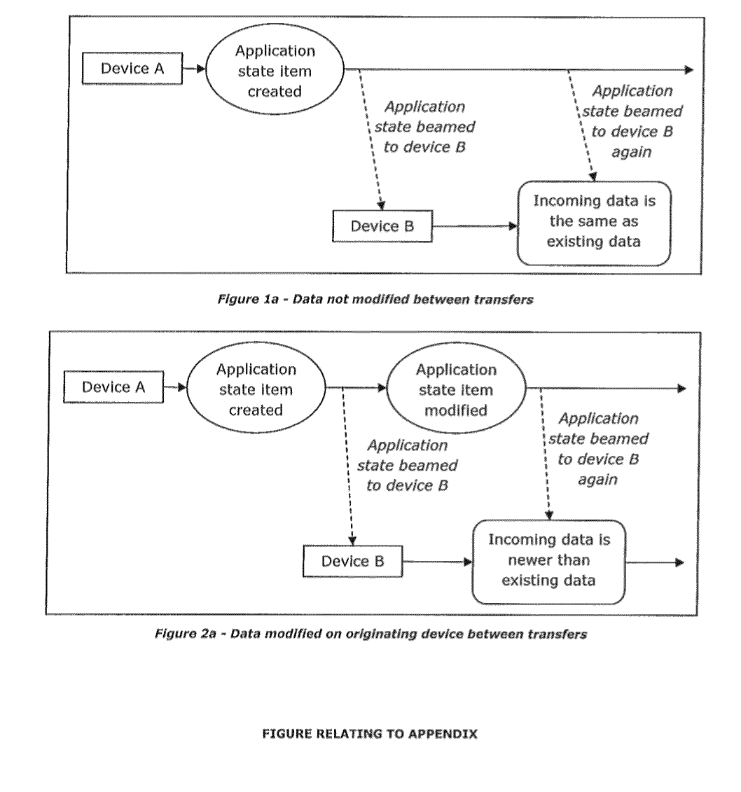

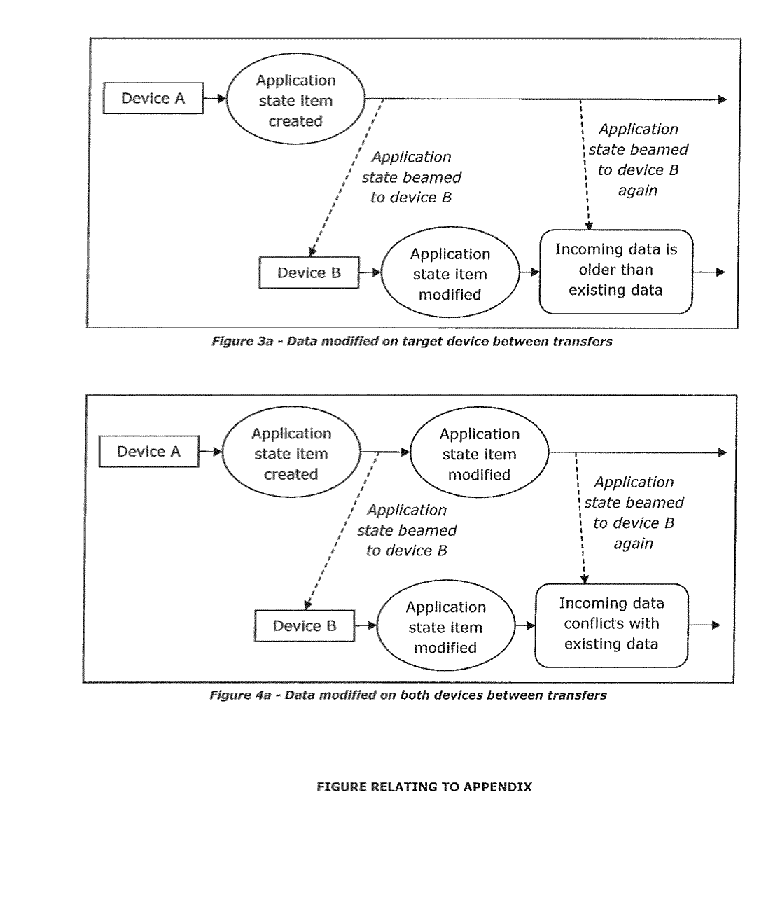

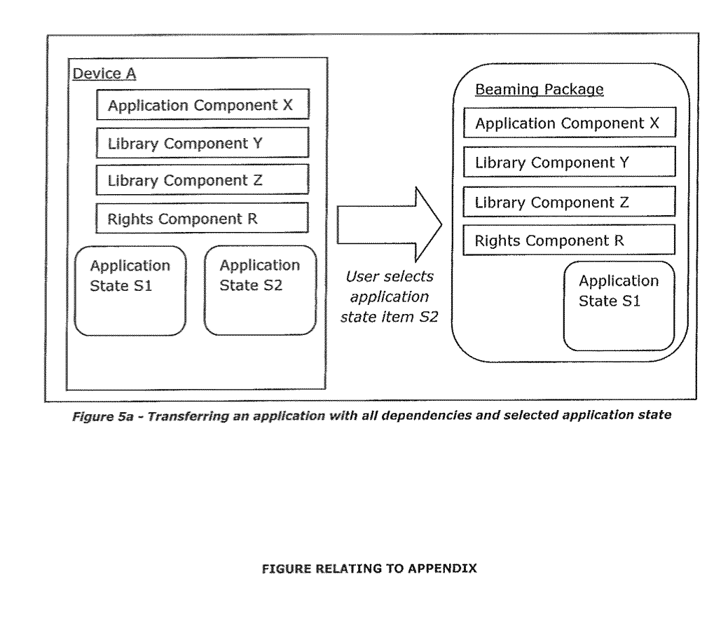

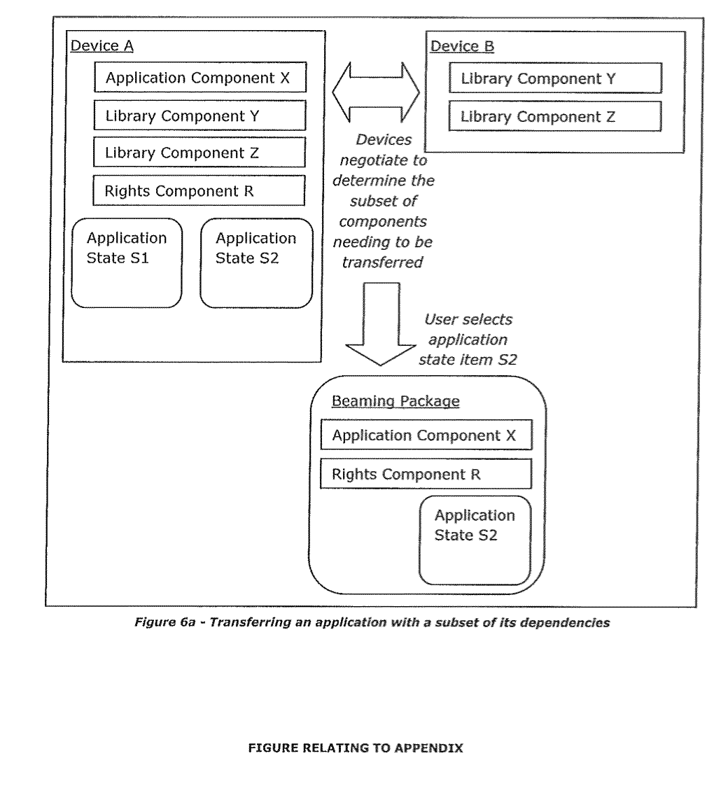

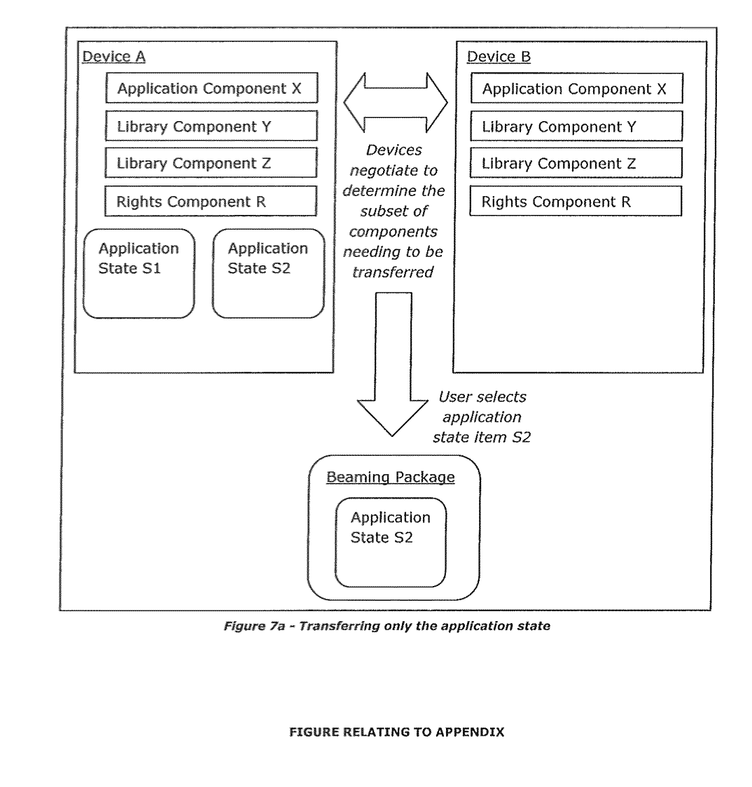

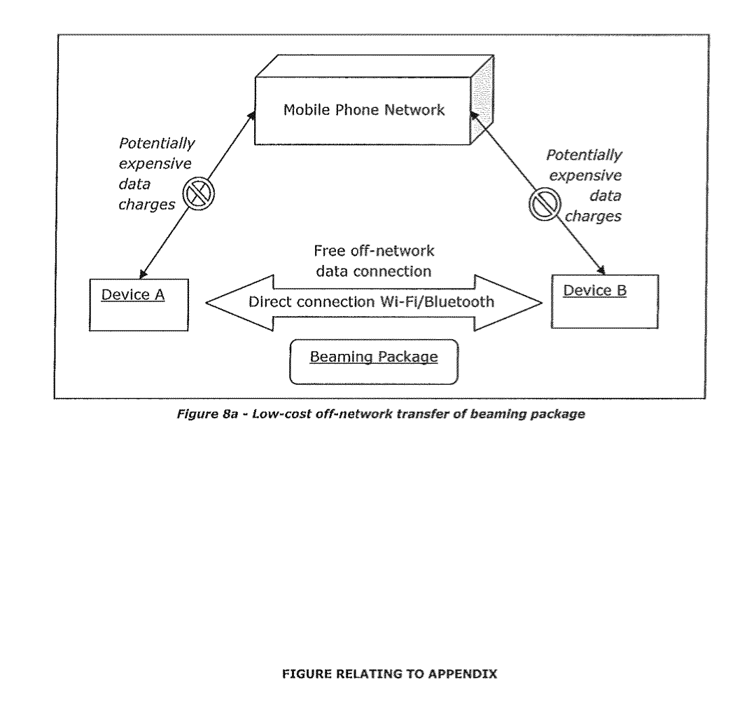

FIG. 15 shows the use of SRP protocol to verify knowledge of PIN or passphrase and initiate encrypted communication link; and

FIGS. 1a to 8a are referred to in the appendix.

### 2. DETAILED DESCRIPTION

### 2.1 Prerequisites

The preferred embodiment of this invention is an extension of the systems described in [1] and [2]. It uses the same binary-portable software distribution format, packaging format, dependency mechanism and so on as described in [1], and extends the meta-data system described in [2] to handle the specific use-case of remote device input. The reader is assumed to be familiar with [1] and [2].

### 2.1.1 Recap of Relevant Parts of PCT/EP2010/056123 (WO 2010/145886)

As described in [1]:
The binary-portable software-distribution format takes the form of an intermediate compiler representation of the application program, where the final step of the compilation (code generation, register allocation, etc) is done on the target device when the exact CPU architecture is known.
The packaging format is an extension of the “JAR” file format, called the “ATX” file format. The extensions to the JAR format are simply the definition of some custom manifest properties.
ATX files can have two modes: files containing application code, assets or meta-data (known as ATX components), and files containing other ATX files (known as container ATX files).
ATX components are digitally signed using the standard cryptographic algorithms used by the Java “jarsigner” tool. This is used to ensure authenticity of the content of the ATX file.
Container ATX files are not signed, but the ATX files contained within them typically are, so the authenticity of the content can be verified anyway.
Each ATX component contains a “manifest”: a file containing certain name/value pairs (known as “properties”) which define various important pieces of information about the component, such as a unique component name and an associated version number, declarations of the interfaces implemented by the component (also with associated version numbers), and dependencies on other components or interfaces, each specifying the valid range of version numbers for that component name or interface.
Each device has a unique device identifier. This is used in [1] to lock rights components to specific devices by encoding the relevant device unique IDs into a rights ruleset.

### 2.1.2 Recap of Relevant Parts of UK Patent Application 1021875.8 (see Appendix)

As described in [2]:
Application, library, rights and meta-data components can be packaged together into a “beaming package”.
A target device is determined using an appropriate mechanism such as network broadcast, service discovery, or manual user input.
The source device and target device can exchange information about components which are already installed on the target device, so that such components can be removed from the beaming package by the source device, thus reducing the size of the data to be transferred.
A meta-data component is generated and included in the beaming package which contains certain application state data, such as game save information, settings, user-generated content such as game characters, etc. It also contains an item of data (the “AGC-State-AppDependency” manifest header) identifying the application which should be used to process it on the target device.
On receipt at the target device, any application, library or rights components within the beaming package are installed. The meta-data component generated above is extracted and its contents made available to the associated application in such a way that they can be located by the application.

### 2.2 Application Sessions and Session State

A group of associated software applications are produced, which are designed to communicate over some communications medium and exchange information to display and manipulate a combined set of state data. This group of applications may comprise several separate applications each of which performs a distinct role within the group (see FIG. 4 for example), or a single application which can perform all of the necessary roles itself (see FIG. 3 for example).

One or more of the applications within this group, potentially running on independent computing devices and communicating together, form a “session”. The combined set of state data is associated with this session.

Depending on the architecture of the applications, there may be several different applications communicating together within a session—for example one of the applications might be a “controller” application and the others “slave” applications (see FIG. 2 for example), or there may simply be a single application which can communicate with other instances of itself running on different devices, in a peer-to-peer fashion (see FIG. 3 for example).

Typically, although not necessarily, all of the applications in the group are distributed together, either in a single ATX component (where the applications are written as multiple programs within a single component) or else in a container ATX (where the applications are written as separate components). As a result, from any device where any of them is present, the others are also present and thus available for beaming (see FIG. 6 for an example of beaming from a first device to a second device, and then from that second device to a third device).

The data representing the overall session state may be retained within the memory or other storage of a single application within the session (with the others retaining some subset of it which is necessary for them to perform their operations), it may be shared by all of the applications within the session, or it may be distributed—not retained in its entirety by any of the applications but being formed by the combined set of application state data retained by all applications in the session.

Each application takes input from the computing device on which it is running, and displays certain output to the user. Different applications within the session or instances of the same application running on different devices within the session may each display a different set of information to the user of that device (see FIG. 2 for example).

Information regarding user input may be transmitted to other applications within the session, either in the form of data which represents specific input events (such as a mouse movement or a key press), or in the form of data which represents semantic events within the context of the specific group of applications (such as a request by the user to play a specific music track, to make a move in a game, etc).

### 2.3 Transferring Software Applications to Remote Devices

In order for a computing device to be able to take part in an application session as described in this document, the relevant software applications must be deployed on the devices.

The mechanism by which this takes place is the same as the method described in [2], which specifies the method by which dependency negotiation takes place between devices, and how “beaming packages” are created.

This section gives some more concrete examples of how this method is used to transfer software applications for the purposes described above.

Selection of a target device for the transfer of a software application can be done in a number of ways, including but not limited to:
Use of a well-known service-discovery protocol over a transport medium such as Bluetooth.
Use of a custom discovery protocol, typically using some form of broadcast over a wired or wireless transport medium using TCP or UDP over IP.
Manual entry by the user of information identifying the target device. This information could be a network address such as an IP address, or it could be a more user-friendly form of identification such as a fully-qualified internet domain name or a NetBIOS name.

These techniques are illustrated in FIG. 13.

On some software platforms it may be necessary for the target device to be manually placed by the user into a state where it is ready to receive or respond to such discovery requests or connections.

On other software platforms, it may be possible for such a discovery client program to remain running at all times, or to be registered with the software platform such that it is automatically invoked when an incoming connection or request is detected.

Once the target device has been identified, a connection is established to it from the source device. Although [2] also describes a system whereby a bi-directional communication channel is not required for application software transfer, it is preferable for the two devices to be able to negotiate the subset of software and other information needing to be transferred in order to reduce network utilization and increase transfer speed. A bi-directional connection over which dependency negotiation can be performed therefore forms part of the preferred embodiment.

Once the connection has been established (or as part of its establishment), security mechanisms are used to prevent unauthorized transfer of applications. This typically takes the form of encryption of the connection along with the use of a passphrase or Personal-Identification-Number (PIN) which must be entered on both devices in order for the transfer to succeed.

The users may be offered the option of “pairing” with the other device, allowing future application software transfers to take place from that device without requiring the use of a passphrase or PIN.

The security protocol should include a mechanism for each device to uniquely identify itself to the other, preferably in a manner whereby each device does not transmit information which could be used by another device to impersonate it (for example by using a replay attack).

A number of such systems exist and are well known, such as the Secure Remote Password Protocol [3]. This protocol allows two devices to prove to each other than they both have the PIN or passphrase, without exposing any information about it which could be used by an eavesdropper to impersonate either device. In addition, this protocol results in both parties having a shared (but secret from any other party) key which can be used for encrypted communication. This protocol is used in the preferred embodiment, and is illustrated in FIG. 15.

Having made a connection between the devices and established an appropriate level of security and authenticity for the application software transfer operation, the dependency negotiation process described in [2] can now take place. FIG. 12 illustrates this process, resulting in the production of a list of software applications or other components which need to be transferred in order for the software application to work on the target device.

In some cases this list will be empty—for example where the software has already been transferred to the target device during a previous transfer operation, or where the software was independently installed on both devices.

Document [2] describes the use of a meta-data component which is not cryptographically signed to contain information about application state. This document details a use-case for this mechanism where the meta-data component contains information about the desired action for the target device to take (e.g. which application component to start, and using what parameters), plus additional information identifying other computing devices within the session which the target device will become part of when the relevant program is started.

This information is likely to take the form of one or more network addresses and port numbers or service IDs—for example in a simple case this would identify the network endpoint via which the target device can connect back to the originating application on the sending device.

As described in [2], this meta-data component is packaged with any application, library and rights components needing to be transferred and transferred to the target device. The components are installed and processed on the target device as described in [2].

### 2.4 Meta-Data Component Identifying Desired Action and Existing Session Members

The meta-data component (identifying the desired actions for the receiving device to take and the existing session members) needs to be generated dynamically when the user selects the action to take, since various pieces of data such as the network endpoints may differ each time the beaming package is generated.

There are a number of ways in which this meta-data could be generated, such as by the application declaring certain information such that the software framework can generate all of the necessary meta-data, potentially including the automatic allocation of a network endpoint, prior to starting the local application.

In the preferred embodiment described here, the generation of the meta-data is performed primarily by the application itself, although potentially making use of libraries provided by the software framework to perform various aspects of the work such as the packaging and formatting.

The user first selects which mode they wish the local device to operate in—in other words which application role they wish it to perform (server, client, master, slave, peer, etc). The possible set of roles depends on the specific application or group of applications.

The user may do this by running a specific application from the group of applications which can communicate together in a session, or by selecting an operating mode from within an already running application (for example, where the same application can perform multiple roles).

Having done this, the user is given the option to start a new session, with the application presenting the available options. There are many possible application configurations, but some examples are:
The user has selected the local device to act as a remote program. The user is presented with the chance to run the host program on another device.
The user has selected the local device to act as a host program. The user may be able to operate this program entirely using the local device, but an option may also be presented to allow the user to run the remote program on another device (in multi-player games, the user may well be allowed to select multiple remote devices, each representing a different player).
The user might be offered the chance to join an already existing session.

Many other possible application configurations exist, and the application should present the appropriate options to the user.

If the user wishes to join an existing session, it is up to the application to discover such available sessions in an application-specific manner, and to negotiate with the existing session members to allow access.

If the user selects an option indicating that they wish to initiate a new session, the application performs device discovery to identify the target device. This target device must support the necessary protocols and software framework to be able to receive and process beaming packages as described in [2], and so this device discovery will typically be facilitated by using a library provided by the software framework on the local device. This device discovery procedure is described in more detail above.

Having identified the target device, the application can allocate a network endpoint on an appropriate network medium. Typically this will be the same network medium that was used to discover the target device (such as Bluetooth or Wi-Fi), but this is not strictly necessary—there may be a mechanism to determine that both devices are able to communicate over a different medium than that used for discovery, and such a medium may be selected in preference due to criteria such as speed, power utilization, latency, security, etc. FIG. 8 shows an example of this use-case.

At this point all information necessary to build the beaming package is available. The application calls a library function provided by the software framework, passing in as parameters:
The identity of the target device (perhaps in the form of a handle or other identifier returned by the earlier use of the device discovery library).
The set of components which need to be available on the target device. Typically this will include one or more application components. The software framework will automatically extend this set with additional components which are dependencies of the application components as required.
An identifier (a URI) which identifies the program on the target device which should receive the meta-data component (see the “AGC-State-AppDependency” manifest header specified in [2]).
Application-specific data specifying what the application program running on the target device should do (for example, which mode to start up in) and the network endpoint for the target device to connect back to.

The application-specific data is packaged into a meta-data component (see FIG. 14 for illustration), and a beaming package is created containing this and the set of application, library and other components as determined by the software framework. This beaming package is transferred to the target device as described above.

### 2.5 Network Endpoints

The network endpoints transferred in the meta-data component are text records specifying the remote address to connect to.

These are comprised of a number of elements:
The network medium and/or protocol (the “address family”).
An “address”, specifying a networked device to connect to, and typically also a specific service or port number to connect to on that device. The format of this address is specific to the “address family”.

For IPv4 endpoints, the address is formed of a 32-bit value identifying the target device (typically formatted as a “dotted quad”), a 16-bit port number and a flag indicating whether the endpoint is connected (TCP) or datagram (UDP).

For IPv6 endpoints, the address is a 128-bit value identifying the target device (typically formatted as 8 groups of 4 hexadecimal digits, separated by colons), a 16-bit port number and a flag indicating whether the endpoint is connected (TCP) or datagram (UDP).

For Bluetooth endpoints, the address is a 48-bit value identifying the target device (typically formatted as 6 groups of 2 hexadecimal digits, separated by colons) and a 128-bit service UUID.

### 2.6 Receipt of Beaming Package

As discussed in [2], the beaming package is received on the target device and installed. To recap, this takes place as follows:
Any application, library or rights components are installed as described in [1].
Any meta-data components conforming to the description in [2] are installed as described in [2], whereby the associated application is automatically determined, and the contents of the meta-data component are made available to the application in such a way that they can be enumerated by the application on startup (or at another convenient time).

As discussed above, in the particular case described in this document, the application, library and rights components represent one or more application programs from a group of application programs which are able to communicate over a network link to form an “application session”.

Once the beaming package contents have been installed, the application identified by the “AGC-State-AppDependency” property in the meta-data package is automatically started (or switched to, if it is already running). This may be subject to user confirmation.

When this application starts or is switched to, it enumerates the “incoming” items of meta-data using the system described in [2]. Upon finding the meta-data item generated as described in section 2.4, it retrieves the application-specific data which specifies the desired actions and network endpoint. It acts upon these instructions by switching to the requested application mode, and making a connection to the specified network endpoint. As described above, the originating device should already be listening for this network connection, and session setup and further operation should proceed immediately.

FIG. 11 shows the operation of the target device upon receiving a beaming package.

### 2.7 Using an Application-Specific Remote Program

The system described above describes all of the common aspects involved in the transfer of an application-specific remote program. The remaining details are application-specific, such as the details of the protocol and the exact functionality of the application programs within the group which form a session.

However, a few more points can be mentioned which describe the benefits of using an application-specific remote program (or more generally, a number of associated applications which communicate in a session).

The ATX packages described in [1] can contain program code (binary-portable program code in the preferred embodiment), graphical and audio assets, as well as other application-specific data formats such as game level maps, etc.

Not only can the amount of data transferred be vastly reduced compared to a naïve input/output virtualisation system, but also state information can be cached at both ends of the communication link (or more generally, on all devices running programs which are participating in a session) between sessions.

This further reduces network traffic by reducing the amount of data that must be transferred between devices on subsequent session start-up. In turn, this reduction in network traffic results in faster start-up and an improved user experience.

When the application running on the host system has some kind of state change which requires the screen on the remote device to be changed, or an audio file played, the information needing to be transmitted across the network is minimal—simply the data describing the state change. The graphics can be updated on the remote device and audio played as necessary with low bandwidth requirements and low latency.

Similarly, not all input events need to be sent to the host device—the program running on the remote device can take a number of independent actions before reporting the results to the host device.

FIG. 9 illustrates the application-specific remote program case.

### 2.8 Generic Remote Program

Although this description discloses the semi-automatic transfer and start-up of some subset of a group of application programs able to communicate together in a session, the system described above can easily support a “generic remote program”—one which is not specific to the host application program.

Using this approach, the host application program code can be either relatively—or completely—unchanged and still support this facility.

The range of inputs and outputs which can be gathered and displayed on a remote device is less comprehensive than can be achieved using an application-specific remote program, but this is still a useful facility.

A generic remote program would typically be a program which is written to communicate using a network connection with some software running as part of the software framework under which the host application program is running. Thus, this software can insert input events and gather output data from the host application without any need to change the host application program itself.

The generic remote program could simply communicate the literal input events that the user triggers on the remote device using the input devices available (buttons, touch-screen, accelerometer, etc), or it could perform some translation or simulation of input events—for example by allowing the user to simulate different input events by touching different areas of a touch-screen (for example, a four-directional keypad, an analogue joystick, a keyboard, etc). A suitable graphic would be displayed in this case to guide the user's input.

The generic remote program could provide the user with a mechanism to switch between different input modes, allowing the user to simulate input from a number of different input devices using a touch-screen or other single input device.

In addition, the network protocol used to communicate between the host device and the remote device could include notification of which host application program is being run on the host device. This allows the generic remote program to record which input settings have been selected by the user for different applications, and to automatically switch into the remembered mode for the host application being used.

The program implementing host side of the generic remote protocol (which typically acts as part of the software framework in which the host application is running, or is closely linked to it) may be able to receive feedback from the host application about which input devices it wishes to receive input from (perhaps by the host application calling some API which enables particular input devices). This information can be communicated to the generic remote program such that an appropriate input mode can be automatically selected for a host program, without the user having to manually select a mode.

Simple outputs such as audio output and vibration can be controlled in a similar way, although the additional latency of transferring audio data across the network connection may make this impractical in some cases. Spot-effects, where the application registers a sample to be played at a later time and later triggers the playback, are likely to work better than streaming audio—the APIs available to the application in a particular software environment may determine whether this is feasible.

FIG. 10 shows the generic remote program case.

### 2.8.1 Operation of a Generic Remote Program

The generic remote program could work in a variety of ways. The preferred embodiment is as follows.

The generic remote program is first run by the user on the remote device. At this point, the user is given a number of choices:
Search for an existing session. If this option is selected, the generic remote program attempts to connect to an existing running instance of the software framework which is already running the host side of the remote protocol.

This may be done using a broadcast/multicast mechanism, or by enumerating a set of devices with which the remote device has previously communicated or with which it is “paired”.

If successful, the remote device becomes part of the existing session.
Run a program on another device and connect to it using the generic remote protocol. If this option is selected, the sequence described above in section 2.4 is initiated, where a target device is selected, a program to run is selected, and a beaming package is created.

The meta-data component within the beaming package is generated from data supplied by the generic remote program. It specifies that the program to run on the remote device is some kind of “stub” application which implements the host side of the generic remote protocol. In addition, it specifies the program to be run, as previously selected by the user, and the network endpoint on which it is listening for connections.

Any software components necessary to run the selected application are included in the beaming package using the mechanism described above and in [2]. In addition, if necessary any software components required to operate the host side of the generic remote protocol may be included. In some embodiments these are built-in to the software framework, but in other embodiments these are separate and can be “beamed” in the same way as any other application software as described in [1] and [2].

Upon receipt of this beaming package, the target device (in this case, this is the “host” device) installs any necessary software components and makes the meta-data package available in the “incoming” area of the corresponding application as described in [2], and invokes the associated application.

In this case, the associated application is the application which handles the host side of the generic remote protocol. It starts up, makes a connection back to the network endpoint on which the generic remote program is listening, and then invokes the specified application program (which was selected by the user on the remote device).

Depending on the software environment, it may be possible for both programs to run simultaneously, or it may be necessary for the first program to exit, chaining on to the selected application program in some way which allows the necessary portion of the first program to remain present in the computer's memory such that it can communicate with the generic remote program and insert input events into the host program and intercept its outputs.

The details of this are operating-system-specific and application-specific, and are not addressed here, but examples include the use of “terminate and stay resident” programs, operating-systems which allow multiple programs to run simultaneously, etc.
A degenerate variant of the previous option, where the user selects a remote device and a program to run on that device, but no remote input device is set up.

This is simply a means of beaming and/or launching the application on a target device. The same mechanism described in the previous option is used, but the network endpoint to connect back to is omitted from the meta-data component.

At the receiving end, the application which usually handles the host side of the generic remote protocol starts as described above after the installation of any necessary components from the beaming package, but due to the lack of a remote network endpoint it simply invokes the host application selected by the user. In this case, there is no need for the first application to remain running or resident in memory while the host application runs.

### 3. USAGE SCENARIOS

### 3.1 Single Remote Program

In one embodiment there is a single remote program connected to the host program, allowing the user to control the host program by using input devices on the remote device.

FIG. 1 shows this use-case.

### 3.2 Multiple Instances of Remote Program

In another embodiment there is more than one instance of the same remote program connected to the host program, where each remote program allows the user to control the host program as above, but in this scenario the remote devices may also show information which is private to the user of that specific remote device, such as cards in a card game such as Poker, or the position of their ships in Battleships. The host device shows only the shared information which is public to all users.

FIG. 2 shows this use-case.

### 3.3 Multiple Instances of Single Program

In another embodiment there are multiple instances of the same application acting as peers (no overall controller). Typically in this scenario, each application communicates with all others within the session, rather than with a single controlling application instance.

FIG. 3 shows this use-case.

3.4 More than Two Applications within Group

In another embodiment there are more than two separate applications within the group of applications which can communicate in a session. There may be multiple instances of some of these applications within a session, typically running on different devices.

FIG. 4 gives an example showing this use-case.

### 3.5 Binary Portability

The binary-portable nature of the software described in the preferred embodiment means that it is usable across a wide range of remote devices, varying in terms of hardware (CPU, input devices, etc) and software (operating-system).

To give a concrete example, the host device might be a set-top box or a television, and the remote device might be a mobile phone running Android, Windows-Mobile, Symbian, Linux, etc, and having a CPU with the ARM, MIPS or x86 architecture, or a variety of others. This might have touch-screen input, a simple numeric keypad, an accelerometer, etc.

FIG. 5 shows an example of this use-case. Note that the same binary-portable remote program is used on several different devices, and it can be packaged and beamed with the binary-portable host program between all of these device types and many more (any device supporting the necessary software framework to run the binary-portable applications).

3.6 Beaming Host/Remote Programs from Portable Device

In this use-case, a user with an application on his portable device (such as a mobile phone) can beam the application along with its remote program to another portable device and/or a fixed device such as a television.

A session can then be initiated between these devices, where the originating device can be running either the host or the remote program (or any other application within the group).

FIG. 6 illustrates this use-case.

3.7 Beaming Remote Programs from Fixed Device

In this use-case, a user downloads (or otherwise installs) an application on a fixed device such as a television or set-top box. He then beams the remote program for the application (typically along with the application) to one or more portable devices such as mobile phones, digital audio players, etc.

A session can then be initiated as in the previous use-case. In this scenario the originating device (the fixed device) would typically run the host program and the portable device would run the remote program.

FIG. 7 illustrates this use-case.

3.8 Use of a Different Network Medium for Discovery than for Later Communication

In this use-case, the originating and target device use a different network medium for bulk data transfer than they do for device discovery.

This may be for reasons of functionality, speed, latency, power utilization, security, etc. For example, one medium might support multicast or broadcast or a standard service-discovery mechanism, making it preferable for the discovery part of the operation. Another medium might have different advantageous characteristics which make it the preferred medium for bulk data transfer.

FIG. 8 illustrates this mechanism, using the network media Bluetooth and Wi-Fi as examples.

In this figure, Device A discovers Device B using the standard Bluetooth Service Discovery Protocol. This allows Device B to advertise that it supports the beaming and/or application session protocols described in this document and allows Device A to search for devices supporting the relevant protocol.

The devices initiate a data connection over the Bluetooth network. Using this connection, they communicate their network addresses on any other network mediums (for example their IP addresses on the Wi-Fi network).

For any networks which they both have addresses on, Device A opens a listening connection and randomly generates a security key. The network endpoint information and random key are sent across the Bluetooth connection to Device B, which attempts to connect to the specified network endpoint. In the example shown in FIG. 8, the listening endpoint that Device A creates might be a randomly assigned port number.

Note that the devices don't necessarily have enough information to determine that they are on the same physical or logical network, but they can determine that they are both on a network using the same protocol (for example, they both have IP addresses), so they can attempt to communicate.

If Device B successfully manages to connect to the specified network endpoint (in this case an IP address and port number), a security exchange takes place whereby each device verifies that the other has the correct security information (without revealing the security information).

In addition, other information may be exchanged and tests may be made to determine whether the connection is suitable for bulk data transfer—for example, the devices may need to determine that they are on the same physical or logical network and so use of the connection will not typically incur significant data costs. This may be done in the IP protocol by setting the TTL (time-to-live) field to a small value so that packets do not get routed outside of the local network.

If these negotiations take place successfully, the Bluetooth connection can be closed and all further data transfer can take place over the new connection. If not, another network address may be attempted if available, and as a last resort the Bluetooth connection may be used for the bulk data transfer.

### REFERENCES

[1] RIGHTS MANAGED DISTRIBUTABLE SOFTWARE: PCT/EP2010/056123: Shelton (Published as WO 2010/145,886)
[2] UK Patent Application 1021875.8: Beaming of Binary-Portable Software Including Dependencies and Application State This UK application corresponds to the appendix of the present application.
[3] T. Wu, “The Secure Remote Password Protocol”, In Proceedings of the 1998 Internet Society Symposium on Network and Distributed Systems Security, San Diego, Calif., pp. 97-111.

### APPENDIX

### This is a Complete Copy of UK Patent Application 1021875.8: Beaming of Binary-Portable Software Including Dependencies and Application State

### Methods of Distributing Software

### 1. FIELD OF THE INVENTION

The present invention relates to a method of distributing software, and to computer readable media carrying such software. It relates in particular, although not exclusively, to software such as computer games which are designed to be exchanged between users of portable devices such as mobile phones.

### 2. INTRODUCTION

Many general-purpose computer systems allow a user to copy application state data manually—for example word-processor documents, etc. It is also quite common for games consoles to allow the user to copy saved game state onto external media (for example the WII and GameCube consoles allow this).

Some gaming platforms allow a user to transfer certain game state information such as recordings of a car race to other players, such that the receiving player can effectively race against a recorded game and is challenged to try to beat a particular score or time. High-scores are another example of game-state items which are commonly shared among a community of players.

The J2ME Java application environment for mobile devices in some cases has the facility to send applications directly from one user to another.

According to the present application there is provided a method of distributing binary-portable software comprising:
(a) running a software application on a first user device and storing application state data defining a state of the software application;
(b) receiving from a second user device details of required software components needed to run the software application and not already installed, or details of required software components needing updating;
(c) generating a package for transfer to the second user device including the application state data and the required software components;
(d) transferring the package to the second user device;
(e) determining whether the said state has already been saved at the second user device; and
(f) providing an option to a user of the second user device to run the software application from the said state.

The invention further extends to a computer-readable media storing program code for implementing on a digital computer (such as a mobile phone) the method of claim 1.

The invention may be carried into practice in a number of ways and several specific embodiments will now be described by way of example, with reference to the accompanying figures, as follows:

FIG. 1—Data not modified between transfers.

FIG. 2—Data modified on originating device between transfers.

FIG. 3—Data modified on target device between transfers.

FIG. 4—Data modified on both devices between transfers.

FIG. 5—Transferring an application with all dependencies and selected application state.

FIG. 6—Transferring an application with a subset of its dependencies.

FIG. 7—Transferring only the application state

FIG. 8—Low-cost off-network transfer of beaming package.

### 3. DESCRIPTION

### 3.1 Background

Software applications are typically downloaded from a server or installed from physical media. If downloaded, they often come in installation packages which are discarded after the application is installed.

In many cases, the application has dependencies (other pieces of software) which are required in order for it to work. These are typically either installed manually by the end-user, or included unconditionally in the application's installation package.

Simply installing an application and its libraries is not sufficient to transfer the state of an application from one device to another. Applications generally save data to persistent storage to allow information to persist across different invocations of the application.

This data is described as “application state” in the present patent application, and includes items such as:
Settings
Documents
The current state of an in-progress game
A record of a completed game
User-generated content such as game characters or levels
   along with many others.

Traditional systems do not provide a managed way to take an application installed on one device and transfer it to another, including any necessary dependencies and the application state.

This patent application describes a novel system for doing this for binary-portable software applications across dissimilar device types, whereby parts of the application which are already present on the target device are not transferred, thus reducing the size of the data being transferred and thus the time taken and the costs.

### 3.2 Benefits

This approach provides some important advantages for the user:
It is very easy for users to transfer applications and their state between dissimilar types of devices where traditionally this is difficult
Because the transfer is (or at least may be) directly from one end-user device to another, this can be done across a cost-free network such as Bluetooth if the users are in close proximity, thus the bandwidth costs of performing such a transfer over a mobile phone network are greatly reduced or eliminated entirely
Transferring applications is possible even where there is no mobile-device network coverage, over short-range zero-infrastructure networks such as Bluetooth or ad-hoc Wi-Fi
The time taken to transfer the application is reduced by analysing the dependencies and transferring only those parts of the application and its dependencies which are required on the target device and are not already present.
Short-range local transfers are typically faster than the mobile phone network in many cases, particularly in developing countries. This also reduces the time taken to transfer applications.

The method preferably includes managed “version control” which automatically notifies the application when new state data is received and which tracks whether it is older, newer or the same as any corresponding state data item already on the device.

The application may be packaged along with the application state data (along with any required libraries) in such a way that the resulting package can be sent as a unit to another device which can then allow the user to view/modify the application state even if the corresponding application was not previously installed on that receiving device.

This allows use-cases which are not commonly available, such as sending a game challenge (as described above) along with the corresponding game, so that the recipient can attempt to beat the sender's score even if they do not already have the game installed. This could be used as a form of try-before-you-buy to encourage the recipient to purchase the game.

There are also benefits to mobile phone network operators. Mobile phone networks struggle with the increasing bandwidth requirements of smart devices, even in developed counties where network coverage is good.

In developing countries the network coverage and the bandwidth availability over mobile phone networks can make it difficult to transfer even modest sized applications in a reasonable time. Transferring large applications such as advanced 3D games takes so long as to make it prohibitive.

The system described here allows network operators to offer an enhanced user experience without requiring costly improvements to the network infrastructure.

Other fields of use include distributed computer systems, TVs, hand-held and fixed gaming consoles and the like.

### 3.3 Prerequisites

This preferred embodiment is an extension of the system described in the present applicant's published PCT application WO/2010/145886, and uses the same binary-portable software distribution format, packaging format, dependency mechanism and so on as described in that document. The reader is assumed to be familiar with this publication. In the text, it will be referred to as “the prior publication”. The prior publication is incorporated by reference.

### 3.3.1 Recap of Relevant Parts of WO/2010/145886

The binary-portable software-distribution format takes the form of an intermediate compiler representation of the application program, where the final step of the compilation (code generation, register allocation, etc) is done on the target device when the exact CPU architecture is known.
The packaging format is an extension of the “JAR” file format, called the “ATX” file format. The extensions to the JAR format are simply the definition of some custom manifest properties.
ATX files can have two modes: files containing application code, assets or meta-data (known as ATX components), and files containing other ATX files (known as container ATX files).
ATX components are digitally signed using the standard cryptographic algorithms used by the Java “jarsigner” tool. This is used to ensure authenticity of the content of the ATX file.
Container ATX files are not signed, but the ATX files contained within them typically are, so the authenticity of the content can be verified anyway.
ATX components have within their manifests properties which define various important pieces of information about the component, such as a unique component name (and an associated version number), declarations of the interfaces implemented by the component (with associated version numbers), and dependencies on other components or interfaces, each specifying the valid range of version numbers for that component name or interface.
Each device has a unique device identifier. This is used in the prior publication to lock rights components to specific devices by encoding the relevant device unique IDs into a rights ruleset.

### 3.4 Creation of a Beaming/Transfer Package

In order to transfer (or “beam”) an application from one end-user device to another, a number of pieces of data must be transferred to the target device. In the invention detailed in this document, this is done by selecting the relevant pieces of data and packaging them into a single container ATX file, called a “beaming package”.

The data to be included in this package includes:
The ATX file representing the application program to be beamed, if it is not already present on the target device.
Any software libraries which are not already present on the target device.
A “rights component” containing meta-data indicating where the application may be purchased from, if appropriate (rights components are described in detail in the prior publication).
Any application state selected by the user to be beamed to the target device. For example, the user may have a number of in-progress saved games, but only wish to beam one of them. Alternatively, the user might wish to beam only their application settings, but not any other saved application state.

The data within the beaming package therefore varies depending on data exchanged with the target device and upon user input.

Sometimes it may not be possible to directly communicate with the target device. This may occur, for example, because the devices' network connections go through a NAT firewall so cannot receive incoming connections easily, and the devices are not close enough together to use a short range technology such as Bluetooth, ad-hoc Wi-Fi or a USB cable. In such a case it cannot be determined which pieces of software required for running the application are already installed on the target device, and so as a fallback the system must include all application software and libraries required by the application, or ask the user which parts they wish to send. Note that even in this case where there is no direct connection between the devices, the transfer of the application may still be possible through an indirect communication mechanism such as e-mail.

However, if the two devices can communicate directly, a better approach is possible: they can communicate and discover which parts of the application and library software need to be transferred.

3.4.1 Negotiation with the Target Device

Given that the source and target devices can communicate, it is possible for them to exchange information about what application, library, asset and meta-data components are installed.

The source device starts with a set of components which it knows need to be present on the target device. This will typically include the main application component itself, plus a rights component if one is available.

Given this list of components, the source device can query whether each component is installed on the target device (using the unique component name and version number as a pair of identifiers). If a component is already installed on the target device, it is removed from the list and is given no further consideration.

Alternatively, a component may be retained in the list, and ultimately sent to the receiving device if the receiving device reports that the version of the component it already has installed is older than the version to be sent (there is version information within the component manifest file).

For each component which is not already installed on the target device, the dependencies of that component are added to the list of components to be considered, and the procedure continues. In this way, the entire set of dependencies of the original set of components are enumerated and checked.

It should be noted that the dependencies as described in the prior publication can fulfilled by either a component with a matching component name or by a component which implements a matching interface name. This means that the implementation of the dependency on the target device may be different from the implementation on the source device. This could be because there is an installable component from a different supplier on the target device which implements the required interface, or it could be because the software environment on the target device contains a built-in implementation of the interface.

Device drivers for hardware such as OpenGL-ES are a common example of this—each hardware manufacturer typically provides their own implementation of the OpenGL-ES software using making use of underlying hardware capabilities. In the absence of this, it is possible that a software implementation of the interface might be present (there may be a number of different software implementations in existence from different vendors).

For the application being beamed this is irrelevant. The interface specifies the behaviour that must be implemented, and so as long as the interface that the application requires is present on the target device, the requirement is satisfied regardless of the implementation.

By following the procedure describe here, the source and target devices can negotiate a set of components which need to be transferred in order for the application to work on the target device.

It is also possible that there might be a dependency which cannot be satisfied on the target device, such as when the application requires an interface which can only be satisfied on devices which have a particular piece of hardware (for example an input device such as an accelerometer). This can be detected at this negotiation stage and the beaming procedure can be aborted with an appropriate message to the user indicating the cause of the failure.

### 3.4.2 Application State Data

Applications may save a number of separate items of application state data and the user may wish to select a subset of that data to be transferred to the receiving device; often this subset will be a single item of application state data such as an in-progress saved game.

In the system described here, the application itself is not required to interact with the user in order to allow them to select which items of application state data they wish to include in the beaming package. Instead, the application provides the software environment with some meta-data describing the data, which is later used by the software environment to allow the user to select the application state data.

### 3.4.2.1 Application State Meta-Data

Items of meta-data specified by the application:
User-visible name: Offering the user a choice of different items of application state data to transfer necessitates a user-friendly name for each item. The filename of the data file is not suitable for this, since many operating systems impose restrictions on the characters which are available in filenames, including restrictions on length, ASCII-only characters, lack of case-sensitivity, lack of support for whitespace in filenames, etc. As a result, it is necessary to store the name by which the data should be identified to the user separately from the filename.
Icon: A graphic representing the saved data. For example, a screenshot from an in-progress saved game, or a rendering of a character or level represented by the application state data.
Type: A value specifying what sort of data is represented by the application state item. This allows the available items of application state to be sorted into categories, providing additional information for the user to choose between a number of application state items.

The application provides these meta-data by calling an API function to “register” the application state data as an item which should be available for beaming. The filename of the application state data to be associated with these meta-data is also supplied. The application can update these meta-data later (for example, if the name contains a time-stamp this may need to be updated whenever the data is updated).

The application can call a corresponding function to “deregister” the application state item, marking it as no longer available for beaming (and discarding any stored meta-data).

In addition to meta-data explicitly provided by the application, the software environment automatically records some additional meta-data:
Item ID: A randomly-generated identifier, assigned when the application state item is first registered. Applications are likely to assign names to application state items which follow some pattern, such as the name of a game level, a time-stamp, etc. This makes it quite likely that if an application is used on a number of devices, there could be naming clashes where the same name is used to represent items of application state which are actually not the same.
   Recording a random identifier in the item's meta-data makes it possible to determine with a reasonable degree of certainty whether two application state items actually represent the same underlying piece of data or whether they simply happen to have the same name.
   The randomly generated identifier uniquely identifies a particular item of application state (i.e. to distinguish it from other items of application state) in a way which persists across modifications to the state data itself and also across transfers between devices. It is the mechanism by which the system recognises that two items of application state are “the same”, which is a prerequisite to comparing them to find which is newer or whether a merge is required.
Version Information: Once application state data starts to be transferred between devices, there exist multiple copies of the data, each of which could be independently updated. This introduces additional problems to do with identifying which version of the data is newer, when conflicts occur, etc.
   This is done by recording version-tracking meta-data. This is described in the next section.
Application Name: The name of the application which registers the application state item.
Application Dependency Information: The “AGC-State-AppDependency” property from the application component's manifest. This is encoded into the manifest of the application state ATX file (see below) as a dependency. The application should implement the corresponding interface. This allows the application author to have control over compatibility of changes to the data format of application state files. See “Application State Data Format Changes” for details.
   This information identifies the application which corresponds to an item of state. It is typically assigned by the author of the application.

### 3.4.2.2 Application State Version Tracking

Consider the case where an item of application state data is saved on device A and transferred to device B. There are now two copies of the application state data, either of which might be modified. If subsequently the same item is transferred between these devices again, there are a number of different cases:
Data has not been modified on either device before being transferred.
Data is modified on device A and then transferred to device B again. In this case, the incoming version from device A is newer than the existing version on device B.
Data is modified on device B, but then the data is transferred from device A to device B again. In this case, the incoming version from device A is older than the existing version on device B.
Data is modified on both devices and then transferred in either direction. In this case there is a conflict—neither version is strictly newer than the other, although a naive examination of the file timestamps would imply that there was a strict ordering.

These four scenarios are illustrated in FIGS. 1-4.

It is generally difficult for users to keep track of which versions of saved files are newer than others, and so it is helpful for the system to assist the user by keeping track of changes to the application state data files, detecting these situations and notifying the user.

Clearly this situation is even more difficult for users to keep track of when more than two devices are involved, but the basic cases described above can still be detected and reported to the user.

In the system described by this document, this situation is addressed by storing an ordered sequence of version-record meta-data units where each unit represents a branching or joining point in the lifecycle of the application state item.

A version-record consists of a sequence number (starting at 0 and increasing in units of 1), a hash of the contents of the application state item, and the unique identifier of the device on which the version-record was added (this is the same unique identifier mentioned in the prior publication).

An initial version-record is added when the application state item is initially created. Subsequent version-records are added according to the following procedure:
1. Hash the contents of the application state item (using a method such as SHA-1)
2. Compare the hash against the hash in the previous version-record (the one with the highest sequence number)
3. If the hashes differ, add a new version-record with the next sequence number, the current hash and the current device unique identifier.
4. If the hashes are the same, no new version-record is added.

This procedure for adding version-records is executed at the following points:
Branching: Immediately before an application state item is about to be beamed (or at some user selected time, even in the absence of beaming).
Joining: When receiving an application state item, if there is an application state item existing on the device with the same random ID as the incoming item, this procedure is executed on the existing item.

By following these steps, we build up a history of modifications on different devices. The various scenarios described above can now be distinguished by analysing these version-records:
Data has not been modified on either device before being transferred: The version-records are identical.
Data is modified on device A and then transferred to device B again. In this case, the incoming version from device A is newer than the existing version on device B. The version-records are the same up to the point where the version records finish in the version on device B. The incoming version from device A has some additional records after this point.
Data is modified on device B, but then the data is transferred from device A to device B again. In this case, the incoming version from device A is older than the existing version on device B. The version-records are the same up to the point where the version records finish in the incoming version from device A. The existing version on device B has some additional records after this point.
Data is modified on both devices and then transferred in either direction. In this case there is a conflict—neither version is strictly newer than the other, although a naive examination of the file timestamps would imply that there was a strict ordering. The version-records are the same up to some point, and they both versions have additional records after this point.

### 3.4.2.3 Application State Data Packaging

In the prior publication, there are two modes described for ATX files—signed “ATX components” which contain code, data or meta-data, and unsigned “container ATX files” which simply contain other ATX files, which themselves are typically ATX components.

This document describes a new type of ATX file—an unsigned file containing an item of application state, plus a manifest containing the meta-data associated with that item (the random identifier, type, version information, etc). The meta-data described above is encoded in the standard JAR manifest format as key/value pairs using the following property names for the meta-data items described above:
AGC-State-AppName: Name of application which registered the application state item
AGC-State-AppDependency: The AGC-State-AppDependency header from the game's manifest
AGC-State-ItemName: The user-visible name of the application state item
AGC-State-ItemID: The random ID of the application state item
AGC-State-ItemType: The type of the application state item
AGC-State-ItemUpdate-n: The sequence of version records for the application state item

Since this file is not cryptographically signed, its contents cannot be relied upon not to be modified. A simple (but non-secure) way to make it slightly more complex for an attacker to modify this data would be to append a cyclic-redundancy-check or similar code to the application state data file, and then encode the resulting data file using a stream cipher using a key based on some hash of the manifest. It should be stressed however that this will not stop a serious attacker and is only useful against casual attempts to modify the data.

Using this approach, modifications to the manifest or the data file will typically result in the CRC data being invalid when the data is decoded, allowing the modification to be detected in the vast majority of cases.

### 3.5 Beaming the Package

Using negotiation with the target device, the set of application, dependency and rights components required to run the application but not present on the target can be determined. The user then selects zero or more items of application state to be beamed. In an alternative embodiment, the application state(s) to be beamed may be selected automatically with no user-intervention required. For example, it may be convenient in some applications automatically to beam the most recent application state,

As part of the negotiation process, in one embodiment the receiving device can report to the beaming device the application states that it can accept, or that the user of the receiving device wishes to accept (e.g. by way of a user option). This avoids the beaming device transmitting data which will not or cannot be used at the receiving device.

The ATX files for these application state items are generated and stored in a container ATX file, along with the ATX installation packages for all of the application, dependency and rights components that need to be transferred.

The resulting container ATX file is transferred to the target device over any available transport mechanism. This can include OBEX over Bluetooth, as an attachment to an email message, a custom protocol over a Wi-Fi network or a mobile phone network, etc.

### 3.6 Receiving and Installing the Beaming Package

When a container ATX file is received by the target device, its inner ATX files are examined and a number of actions taken as a result:
1. Rights components are installed, subject to confirmation by the user
2. Application and dependency components are installed, subject to confirmation by the user
3. Any application state items present in the container ATX are processed

The installation of the binary-portable software components in step 2, and the handling of rights components in step 1 are described in the prior publication.

Application state items are processed as follows:
If the application state data file is encoded as described in “Application State Data Packaging” above, the data is encoded by hashing the manifest to produce the decryption key, decrypting the data file and then checking and removing the CRC. If the CRC does not match the transmitted value, the application state item is considered to be corrupt and is discarded.
The AGC-State-AppDependency property from the application state item's manifest is evaluated using the dependency mechanism specified in the prior publication in order to find an application which is capable of handling the application state item being processed. If none is found, the application state item is discarded.
Using the AGC-State-ItemID property from the application state item's manifest, the system determines whether there is an item of application state with the same random identifier existing on the device. If so, it compares the version record information in the two items, and presents the user with a choice of possible actions to take:
   Incoming application state does not correspond to existing application state: The user is asked whether they want to install the application state item, with a default answer of “Yes”.
   Incoming application state corresponds to existing application state, but is newer: The user is asked whether they want to overwrite their existing application state with the incoming application state, with a note saying that the incoming application state appears to be newer. The default answer is “Yes”.
   Incoming application state corresponds to existing application state, but is older: User is asked whether they want to overwrite their existing application state with the incoming application state, with a note saying that the incoming application state appears to be older. The default answer is “No”.
   Incoming application state corresponds to existing application state, but there is a conflict: The user is given the choice of overwriting their existing application state with the incoming application state with a default answer of “No”. If the application's manifest indicates that it can merge this type of application state, the user is also offered a “merge” option, which triggers the application's merge functionality.

If the user does not reject an incoming item of application state, the corresponding data file is stored in a directory visible to the application whose sole purpose is to contain incoming application state data files. In addition, the meta-data for the application-state item is inserted into the target system's record of application state items, in essentially the same way as if the item had been registered in the normal manner by an application. If the user chose to merge a conflict, this is recorded along with the meta-data for the item.

### 3.7 Application Support

A number of small changes may need to be made to applications wishing to make use of the application state beaming facility. These will be evident to the skilled person on the basis of this disclosure.

### 3.7.1 Registering and Deregistering Application State Items

Applications may need to call an API function to “register” a saved data file as being available for beaming, as described above.

The application may also deregister data files, removing any stored meta-data for the file and marking it as no longer available for beaming.

### 3.7.2 Application State Data Format Changes

Sometimes applications may need to change the format of their saved data files. This can happen when features are added or removed, or simply for efficiency improvements, etc.

When this happens, old versions of the application are typically unable to use data files created by the new version, whereas new versions of the application may or may not be able to use data files saved by old versions of the application.

The author of the software application can express information in the application manifest about which versions of the application's data formats are supported using the AGC-State-AppDependency and AGC-InterfaceComponent-n properties.

The AGC-State-AppDependency property is encoded into the meta-data of any application state item created by the application, and into the manifest of any application state items that are beamed to other devices.

This expresses a dependency on a specific interface name and version-range. The application implements this interface. By changing the interface version numbers in these two manifest properties, old application state items can be selectively allowed or disallowed, and new application state data files marked as being incompatible with older versions of the application.

For example:
Application supports one data format, but author expects to provide backward-compatibility with older formats if the data format ever changes
   AGC-InterfaceComponent-0: http://someinterface.mycompanycom/if/game-state/somegame 1.0
   AGC-State-AppDependency: http://someinterface.mycompanycom/if/game-state/somegame 1.0-1.*

In this example, the application states that it supports version 1.0 of the interface. The AGC-State-AppDependency entry which is put into the application state meta-data indicates that it requires at least version 1.0 of this interface, but that it expects future versions of the application which support different data formats to be able to decode it as well.
Application described above has a change to its data format
   AGC-InterfaceComponent-0: http://someinterface.mycompanycom/if/game-state/somegame 1.1
   AGC-State-AppDependency: http://someinterface.mycompanycom/if/game-state/somegame 1.1-1.*

This is an extension of the previous example, in which the data format for application-state has changed. The application now states that it supports version 1.1 of the interface.

Note that this still matches the version range which will exist in application state items created by the earlier version of the application (1.0-1.*). The application is therefore stating that it still supports application state items created by the earlier version of the application which implemented version 1.0 of this interface.

New application state items saved by this application will be assigned the new version range “1.1-1.*”. This will not match the previous version of the application (which implemented version 1.0 of this interface), which is the correct behaviour.
Application changes its data format and drops support for old formats
   AGC-InterfaceComponent-0: http://someinterface.mycompanycom/if/game-state/somegame 2.0
   AGC-State-AppDependency: http://someinterface.mycompanycom/if/game-state/somegame 2.0-2.

This can be considered as an extension of the previous example in which the application author decides to drop support for all previous application state data format versions, or it could be used in a situation where the author never had any intention of providing backward-compatibility for older data formats. Regardless of the intention, the mechanism is the same.

The application state meta-data from older versions of the application will require a version number in the range “1.*”, so will not match this new version of the application. The application has therefore declared its incompatibility with those versions.

By modifying the major version number, the application authors can keep control over whether they want to retain backward compatibility at each change to the data format.

3.7.3 Actions Taken when Application State Items are Received

When the application starts (or at some other well-defined occasions, such as immediately before displaying a list of saved files for the user to choose from), it is expected to call an API function to enumerate the application state items within the directory described above where incoming application state item data files are stored.

For each item in the enumeration, the application is given the name of the incoming application state data file, the name of the corresponding existing application state data file (if any), information about which is newer and whether there was a conflict, and whether the user chose to install the incoming version or attempt a merge.

The application is required to validate the contents of the incoming application state data file (to check for deliberate modification, corruption, etc). Application state data files are a common attack vector for gaming systems, so it is important the applications robustly check the validity of incoming application state data files to protect against buffer-overruns, etc.

Once the application has validated the incoming file, it should take one of the following actions:
Call an API function to accept the incoming file, giving a filename elsewhere (not within the “incoming” directory) to which the data file should be moved. If there was an existing application state data file with the same AGC-State-ItemID, it will be replaced by the incoming file, including its meta-data. The filename to which the incoming data is to be saved may be the same as the filename of the existing application state data file which is being replaced, or it may be different in which case the existing data file will be removed.
Call an API function to remove the incoming file and its corresponding meta-data. Since by this point the user has already answered “Yes” to the question of whether they want to accept the incoming file, the only situations in which this is likely to be appropriate are if the incoming application state file is invalid or if the application has performed some merging and updated the existing application state data file, so that the incoming file is no longer required.

By following these rules, the incoming directory should only contain files which have recently been received on the device and which require attention from the application, while the application retains control over the naming convention and directory structure of application state files within its data directories.

The application can provide simple merging facilities if it chooses at this point.

For example, a chess game using the application state beaming mechanism to transmit the turns from one player to another might perform a check on incoming state items representing an in-progress saved-game, to ensure that the received game matched its record of the game state (i.e. all previous moves the same) with one extra move having been made by the opposing player. Effectively the incoming application state is merged with the existing state.

More complex merges might be possible if the application state data format contains internally a record of individual changes, enabling the application to detect individual modifications within the file and resolve which items should be retained from each file, perhaps with user confirmation.

### 4. USAGE SCENARIOS

This section describes some use-cases supported by the system described in this document.

4.1 Transferring an Application Along with all of its Dependencies and State

In a situation where there is no direct communication from the source device to the target device, the two devices cannot negotiate the set of application and dependency components which need to be transferred in order to make the application work.

In this situation, it is necessary to transfer the entire set of components. The user may optionally select some application state to be transferred along with the application.

There are many reasons why the source and targets might not be able to communicate directly, including connectivity reasons and also the situation where the target device is not known at the time that the beaming package is created—for example if the source device creates the beaming package and makes it available for download on a publicly accessible web server.

The transfer process is illustrated in FIG. 5.

4.2 Transferring an Application with a Subset of its Dependencies

A more useful case is where the source and target devices are able to communicate. In this case, they are able to determine the exact subset of components that need to be transferred.

Again, the user may choose some application state to be included in the beaming package.

This is illustrated in FIG. 6.

### 4.3 Transferring Only the Application State

The ultimate example of the negotiation between the source and target devices is where they determine that the target device has all of the components that it needs in order to run the application. In this case, only application state items (if any are selected by the user) need to be transferred.

This is illustrated in FIG. 7.

4.4 Transferring Over a Short-Range Network when there is No Phone Network Coverage

A key advantage of this system is the “off-network” transfer of the data—typically over a short-range wireless technology such as Bluetooth or Wi-Fi (including ad-hoc Wi-Fi where no existing Wi-Fi network is required). A wired connection such as USB or Ethernet can also be used where appropriate.

This is illustrated in FIG. 8.
1. A method of distributing binary-portable software comprising:
   (a) running a software application on a first user device and storing application state data defining a state of the software application;
   (b) receiving from a second user device details of required software components needed to run the software application and not already installed, or details of required software components needing updating;
   (c) generating a package for transfer to the second user device including the application state data and the required software components:
   (d) transferring the package to the second user device;
   (e) determining whether the said state has already been saved at the second user device; and
   (f) providing an option to a user of the second user device to run the software application from the said state.
2. A method in which the required software components include any of the following which are not already installed on the second user device: a binary-portable software component, a rights component, and any necessary software libraries or dependencies.
3. A method in which the package includes a binary-portable software component, the method providing the user of the second user device with an option to run from the said state a software application not previously installed.
4. A method including providing an option to a user of the first user device of the desired state to be transferred.
5. A method including receiving from the second user device details of the state or states already stored on the second user device, and excluding from the package said already stored state or states.
6. A method in which the package is transferred without modification from the first user device to the second user device.
7. A method including warning a user of the second user device if the transferred state is older than or conflicts with a state already stored on the second user device.
8. A method in which the application state data defines a plurality of state records, a new state record being added to the application state data when a hash of the most-recently stored state differs from a hash of the current state which is to be saved.
9. A method in which, on receipt of the package at the second user device, a hash of the transferred state is compared with a hash of a state stored at the second user device, and if different, the transferred state is stored at the second user device.
10. A method in which the said state is identified by a randomly-generated identifier and comparing said state with a state or states having the same identifier already stored at the second user device.
11. A method in which the package includes a data format indicator, the said indicator being read by the second user device to determine whether the transferred data format is compatible with the data format in use on the second user device.
12. A method in which the second user device merges the transferred state with a state already stored on the second user device, and runs the application software based on the merged state.
13. A method in which the first and second user devices are mobile phones.
14. A method in which the software application is a game.
15. A computer-readable media storing program code for implementing on a digital computer.

1. A method of distributing a software application for execution across a network between an initiating user device and a receiving user device remote from the initiating user device, the method comprising:
storing at the initiating user device a software package for implementing the software application, the software package including a first program for execution on the initiating user device and a second program for execution on the receiving user device;
broadcasting from the initiating user device across the network a request for response from compatible user devices that are capable of participating in execution of the software application;
on receiving a response from a compatible receiving user device, transferring the second program across the network from the initiating user device to the receiving user device, and installing the second program on the receiving user device; and
executing the software application by running the first program on the initiating user device and the second program on the receiving user device.

2. A method as claimed in claim 1 in which the first program is a host program, and the second program is a remote control program for controlling the initiating user device from the receiving user device.

3. A method as claimed in claim 1 in which the second program is a host program, and the first program is a remote control program for controlling the receiving user device from the initiating user device.

4. A method as claimed in claim 2 in which a user of the initiating user device selects whether the initiating user device is to be used to control the receiving user device, or vice versa, and the second program is selected accordingly from programs available within the software package.

5. A method as claimed in claim 1 in which the first and second programs, when executing on the initiating user device and the receiving user device, represent separate instances of a single common program.

6. A method as claimed in claim 1 in which both the first and second programs are peer to peer programs.

7. A method as claimed in claim 1 including receiving a response from a receiving user device which is already participating in execution of an existing session of the software application, and providing an option to the user of the initiating user device to join said existing session.

8. A method as claimed in claim 1 in which the first and second programs communicate directly at least partially via an application-specific protocol.

9. A method as claimed in claim 1 in which the first and second programs communicate at least partially via a generic protocol.

10. A method as claimed in claim 1 in which the response from the compatible receiving user device takes place over a first network, and the transfer of the second program to the receiving user device takes place over a second network.

11. A method as claimed in claim 10 in which communication between the initiating user device and the receiving user device while executing the software application takes place over the second network.

12. A method as claimed in claim 1 in which the software package, and the first and second programs, are implemented in binary-portable code.

13. A method as claimed in claim 1 including transferring from the initiating user device to the receiving user device either:
the software package, or
those parts thereof that are missing on the receiving user device and are required in order to assemble the software package; and
using the receiving user device as a new initiating user device to further extend distribution of the software application.

14. Computer-readable media storing program code for implementing on a digital computer the method of claim 1.

15. A method as claimed in claim 3 in which a user of the initiating user device selects whether the initiating user device is to be used to control the receiving user device, or vice versa, and the second program is selected accordingly from programs available within the software package.
